(19) United States
(12) Patent Application Publication
(10) Pub. No.: US 2013/0284040 A1
(43) Pub. Date: Oct. 31, 2013

(54) RESIN COMPOSITION FOR LASER ENGRAVING, PROCESS FOR PRODUCING RELIEF PRINTING PLATE PRECURSOR FOR LASER ENGRAVING, RELIEF PRINTING PLATE PRECURSOR, PROCESS FOR MAKING RELIEF PRINTING PLATE AND RELIEF PRINTING PLATE

(71) Applicant: FUJIFILM CORPORATION, Tokyo (JP)

(72) Inventor: Atsushi SUGASAKI, Shizuoka (JP)

(73) Assignee: FUJIFILM Corporation, Tokyo (JP)

(21) Appl. No.: 13/870,668

(22) Filed: Apr. 25, 2013

(30) Foreign Application Priority Data
Apr. 27, 2012 (JP) 2012-103098

(51) Int. Cl. B41N 3/03

(52) U.S. Cl. CPC B41N 3/03
USPC 101/395; 524/537; 524/507; 524/539; 427/385.5; 427/555

(57) ABSTRACT

Disclosed is a resin composition for laser engraving, comprising (Component A) a polyurethane having an ethylenically unsaturated group and having a number-average molecular weight of at least 5,000, (Component B) a compound having at least two isocyanate groups in the molecule, (Component C) a compound having at least two active hydrogens in the molecule, and (Component D) a thermopolymerization initiator.

### CROSS-REFERENCE TO RELATED APPLICATION

This application claims priority under 35 USC 119 from Japanese Patent Application No. 2012-103098 filed on Apr. 27, 2012, the disclosure of which is incorporated by reference herein.

### TECHNICAL FIELD

The present invention relates to a resin composition for laser engraving, a process for producing a relief printing plate precursor for laser engraving, a relief printing plate precursor, a process for making a relief printing plate, and a relief printing plate.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

As a resin composition for laser engraving, those described in JP-B-3801592 (JP-B denotes a Japanese examined patent application publication) are known.

### SUMMARY OF INVENTION

It is one object of the present invention to provide a relief printing plate precursor for laser engraving and a process for producing same in which engraving residue rinsing properties and engraving sensitivity are excellent and film surface tackiness is suppressed. Furthermore, it is another object of the present invention to provide a resin composition for laser engraving that is suitably used for such a printing plate precursor. It is yet another object of the present invention to provide a relief printing plate having excellent ink transfer properties and a process for making same.

The objects of the present invention have been attained by <1> and <24> to <30> below. They are listed together with <2> to <23>, which are preferred embodiments.

<1> A resin composition for laser engraving, comprising (Component A) a polyurethane having an ethylenically unsaturated group and having a number-average molecular weight of at least 5,000, (Component B) a compound having at least two isocyanate groups in the molecule, (Component C) a compound having at least two active hydrogens in the molecule, and (Component D) a thermopolymerization initiator,
<2> the resin composition for laser engraving according to <1>, wherein Component A is a plastomer at 20° C.,
<3> the resin composition for laser engraving according to <1> or <2>, wherein Component A has an average number of ethylenically unsaturated groups per molecule of at least 0.7,
<4> the resin composition for laser engraving according to any one of <1> to <3>, wherein Component A has an ethylenically unsaturated group at a main chain terminal,
<5> the resin composition for laser engraving according to any one of <1> to <4>, wherein Component A has a content of 20 to 95 mass % in the total solids content,
<6> the resin composition for laser engraving according to any one of <1> to <5>, wherein Component A has a number-average molecular weight of 7,000 to 500,000,
<7> the resin composition for laser engraving according to any one of <1> to <6>, wherein Component B is an isocyanate compound having an average number fn of isocyanate groups of greater than 2,
<8> the resin composition for laser engraving according to any one of <1> to <7>, wherein Component B has a number-average molecular weight of no greater than 4,500,
<9> the resin composition for laser engraving according to any one of <1> to <8>, wherein Component B has a content of 5 to 70 mass % in the total solids content,
<10> the resin composition for laser engraving according to any one of <1> to <9>, wherein Component C comprises (Component C-1) a compound having a siloxane bond in the molecule and having at least two active hydrogens,
<11> the resin composition for laser engraving according to any one of <1> to <10>, wherein Component C-1 is selected from the group consisting of a both termini carbinol-modified silicone oil, a both termini amino-modified silicone oil, and a single terminal diol-modified silicone oil,
<12> the resin composition for laser engraving according to any one of <1> to <11>, wherein it comprises at least two types of Component C, and at least one thereof is (Component C-1) a compound having a siloxane bond in the molecule and having at least two active hydrogens,
<13> the resin composition for laser engraving according to any one of <1> to <12>, wherein Component C comprises, in addition to Component C-1, (Component C-2) a compound having at least two active hydrogens but not having a siloxane bond in the molecule,
<14> the resin composition for laser engraving according to any one of <1> to <13>, wherein Component C has a content of 10 to 70 mass % in the total solids content,
<15> the resin composition for laser engraving according to any one of <1> to <14>, wherein the equivalence (molar ratio) of the isocyanate groups in Component B and the active hydrogens in Component C is 70:30 to 30:70,
<16> the resin composition for laser engraving according to any one of <1> to <15>, wherein Component D is an organic peroxide,
<17> the resin composition for laser engraving according to any one of <1> to <16>, wherein Component D has a content of 0.01 to 20 mass % relative to the total solids content,
<18> the resin composition for laser engraving according to any one of <1> to <17>, wherein it further comprises (Component E) a photothermal conversion agent that can absorb light having a wavelength of 700 to 1,300 nm,
<19> the resin composition for laser engraving according to <18>, wherein Component E is carbon black,
<20> the resin composition for laser engraving according to <19>, wherein the carbon black has a dibutyl phthalate oil adsorption of less than 150 mL/100 g and a specific surface area of at least 100 m²/g,
<21> the resin composition for laser engraving according to any one of <1> to <20>, wherein it further comprises (Component F) a compound having a hydrolyzable silyl group and/or a silanol group,
<22> the resin composition for laser engraving according to any one of <1> to <21>, wherein it further comprises (Component G) a radically polymerizable compound,
<23> the resin composition for laser engraving according to any one of <1> to <22>, wherein it further comprises a fragrance,
<24> a relief printing plate precursor for laser engraving, the precursor comprising a crosslinked relief-forming layer formed by crosslinking a relief-forming layer comprising the resin composition for laser engraving according to any one of <1> to <23> by means of heat,
<25> a process for producing a relief printing plate precursor for laser engraving, comprising a layer formation step of forming a relief-forming layer from the resin composition for laser engraving according to any one of <1> to <23> and a crosslinking step of crosslinking the relief-forming layer by means of heat to thus obtain a relief printing plate precursor having a crosslinked relief-forming layer,
<26> a relief printing plate precursor for laser engraving obtained by the process according to <25>,
<27> a process for making a relief printing plate, comprising in this order: a step of preparing a relief printing plate precursor for laser engraving comprising a crosslinked relief-forming layer formed by crosslinking by means of heat a relief-forming layer comprising the resin composition for laser engraving according to any one of <1> to <23>; and an engraving step of laser-engraving the crosslinked relief-forming layer so as to form a relief layer,
<28> a process for making a relief printing plate, comprising an engraving step of laser-engraving the relief printing plate precursor according to <24> or <26> comprising a crosslinked relief-forming layer to thus form a relief layer,
<29> a relief printing plate comprising a relief layer made by the process for making a relief printing plate according to <27> or <28>, and
<30> use of the resin composition according to any one of <1> to <23> in a relief-forming layer of a relief printing plate precursor for laser engraving.

### DESCRIPTION OF EMBODIMENTS

### (Resin Composition for Laser Engraving)

The resin composition for laser engraving of the present invention (hereinafter, also simply called a ‘resin composition’) comprises (Component A) a polyurethane having an ethylenically unsaturated group and having a number-average molecular weight of at least 5,000, (Component B) a compound having at least two isocyanate groups in the molecule, (Component C) a compound having at least two active hydrogens in the molecule, and (Component D) a thermopolymerization initiator.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit. In addition, ‘mass %’ and ‘parts by mass’ have the same meanings as ‘wt %’ and ‘parts by weight’ respectively

Furthermore, ‘(Component A) a polyurethane having an ethylenically unsaturated group and having a number-average molecular weight of at least 5,000’ etc. are simply called ‘Component A’ etc.

In the present invention, a combination of preferred embodiments is more preferable.

When a resin for laser engraving as described in JP-B-3801592 is used, there is the problem that the engraving sensitivity, rinsing properties, and ink transfer properties are not satisfactory.

As a result of an intensive investigation by the present inventor, it has now been found that the use of Component A in combination with Component B and Component C enables a printing plate precursor for laser engraving and a relief printing plate to be obtained in which the engraving sensitivity, rinsing properties and ink transfer properties have improved and film surface tackiness is suppressed.

Although the detailed mechanism is not clear, it is surmised that urethane bonds, which are present in Component A and are also formed by crosslinking between Component B and Component C, are easily thermally decomposed, and a relief printing plate precursor obtained by use of the resin composition for laser engraving of the present invention has high engraving sensitivity.

Furthermore, it is surmised that due to crosslinking within Component A via ethylenically unsaturated groups and crosslinking between Component B and Component C, the crosslink density increases, engraving residue becomes solid, and rinsing properties improve compared with a case in which there is liquid engraving residue.

Moreover, it is surmised that a pseudo-crosslinked structure is formed due to hydrogen bonding of urethane bonds at multiple points, thereby improving the rubber elasticity and improving the ink transfer properties.

In addition, the present inventors have found that the use of Component A to Component C suppresses film surface tackiness, and a relief printing plate precursor having suppressed film surface tackiness is obtained. Although the detailed mechanism is not clear, it is surmised that due to the formation of two types of crosslinked structures, that is, crosslinking based on ethylenically unsaturated groups and crosslinking between Component B and Component C, film viscidity decreases and elasticity increases, and these two factors contribute to suppression of tackiness of the film surface.

In the present specification, with respect to explanation of the relief printing plate precursor and the relief pringing plate, a non-crosslinked crosslinkable layer comprising Component A to Component D and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Constituent components of the resin composition for laser engraving of the present invention are explained below.

### (Component A) Polyurethane Having Ethylenically Unsaturated Group and Having Number-Average Molecular Weight of at Least 5,000

The resin composition for laser engraving of the present invention comprises (Component A) a polyurethane having an ethylenically unsaturated group and having a number-average molecular weight of at least 5,000. Component A may have at least two urethane bonds.

When Component A is not contained, a relief printing plate precursor having excellent engraving sensitivity, rinsing properties, and ink transfer properties, and suppressed film surface tackiness cannot be obtained.

Component A has a number-average molecular weight of at least 5,000. The number-average molecular weight is preferably 7,000 to 500,000, more preferably 9,000 to 300,000, and yet more preferably 10,000 to 200,000. It is preferable for the number-average molecular weight of Component A to be in this range since it is easy to process the resin composition for laser engraving comprising Component A, and a relief printing plate precursor and relief printing plate having excellent strength are obtained.

The number-average molecular weight of Component A is measured using GPC (gel permeation chromatography) and determined using a standard polystyrene calibration curve.

Component A has an ethylenically unsaturated group. Component A has an average number of ethylenically unsaturated groups per molecule of at least 0.7. The average number of ethylenically unsaturated groups is preferably 0.8 to 2.0, and more preferably 1.2 to 2.0. It is preferable for the average number of ethylenically unsaturated groups per molecule of Component A to be in this range since a relief printing plate precursor and relief printing plate that are obtained have excellent mechanical strength and excellent durability.

The average number of ethylenically unsaturated groups per molecule of Component A is determined by analysis of the molecular structure using NMR (nuclear magnetic resonance spectroscopy). In the present invention, ¹H (proton)-NMR is used, but ¹³C-NMR may be used. From the viewpoint of resolution, in the case of proton NMR, it is preferable to use equipment with a measurement frequency of at least 100 MHz.

Component A has an ethylenically unsaturated group, which may be either in a main chain or in a side chain and is not particularly limited, but preferably has an ethylenically unsaturated group at a main chain terminal, and more preferably has an ethylenically unsaturated group at both termini of a main chain. It is preferable for an ethylenically unsaturated group to be at a main chain terminal since high reactivity is obtained due to high mobility of the main chain terminal.

Examples of groups containing the ethylenically unsaturated group that Component A has include a vinyl group, a (meth)acryloyl group, and an allyl group.

Component A is preferably a plastomer at 20° C.

The term ‘plastomer’ as used in the present invention means, as described in ‘Shinpan Kobunshi Jiten (Newly-published Polymer Encyclopedia)’ edited by the Society of Polymer Science, Japan (published in 1988 by Asakura Publishing Co., Ltd., Japan), a macromolecule which has a property of easily undergoing fluid deformation by heating and being capable of solidifying into a deformed shape by cooling. The term ‘plastomer’ is a term opposed to the term ‘elastomer’ (a polymer having a property of, when an external force is added, instantaneously deforming in accordance with the external force, and when the external force is removed, being restored to the original shape in a short time), and the plastomer does not exhibit the same elastic deformation as that exhibited by an elastomer, and easily undergoes plastic deformation.

In the present invention, a plastomer means a polymer which, when the original size is designated as 100%, can be deformed up to 200% of the original size by a small external force at room temperature (20° C.), and even if the external force is removed, does not return to 130% or less of the original size. More particularly, the plastomer means a polymer with which, based on the tensile permanent strain test of JIS K 6262-1997, an I-shaped specimen can be extended to 2 times the gauge length before pulling in a tensile test at 20° C., and the tensile permanent strain measured after extending the specimen to 2 times the gauge length before pulling, subsequently maintaining the specimen for 5 minutes, removing the external tensile force, and maintaining the specimen for 5 minutes, is 30% or greater.

Meanwhile, in the case of a polymer that cannot be subjected to the measurement described above, a polymer which is deformed even if an external force is not applied and does not return to the original shape, corresponds to a plastomer, and for example, a syrup-like resin, an oil-like resin, and a liquid resin correspond thereto.

Furthermore, the plastomer according to the present invention is such that the glass transition temperature (Tg) of the polymer is lower than 20° C. In the case of a polymer having two or more Tg's, all the Tg's are lower than 20° C.

The viscosity of Component A at 20° C. is preferably 0.5 Pa·s to 10 kPa·s, more preferably 10 Pa·s to 10 kPa·s, and yet more preferably 50 Pa·s to 5 kPa·s. When the viscosity is in this range, the resin composition can be easily molded into a sheet-like or cylindrical printing plate precursor, and the process is also simple and easy. In the present invention, since Component A is a plastomer, when the printing plate precursor for laser engraving obtainable from the resin composition is molded into a sheet form or a cylindrical form, a satisfactory thickness accuracy or a satisfactory dimensional accuracy can be achieved.

In the present invention, a process for producing Component A is not particularly limited; examples include a method in which an ethylenically unsaturated group is directly introduced at a molecular terminal of a polymer and a method in which a polymer having a reactive group such as a hydroxy group or an isocyanate group and a compound having an ethylenically unsaturated group and a group that can bond to the reactive group are reacted to thus introduce an ethylenically unsaturated group.

In the present invention, a method for synthesizing Component A having an ethylenically unsaturated group at a main chain terminal is not particularly limited, but the two methods below can be cited as examples.

(i) A method in which first a polyol and a polyisocyanate are reacted to form a polyurethane having an isocyanate group at a terminal with a given molecular weight, and subsequently this polyurethane is reacted with a compound having an ethylenically unsaturated group and an active hydrogen in the molecule.
(ii) A method in which first a polyol and a polyisocyanate are reacted to form a polyurethane having an hydroxy group at a terminal with a given molecular weight, and subsequently this polyurethane is reacted with a compound having an ethylenically unsaturated group and an isocyanate group in the molecule.

Examples of polyols that are used in methods (i) and (ii) include a polyether polyol, a polyester polyol, and a polyether polyester copolymer polyol.

One type thereof may be used on its own or two or more types may be used in combination.

Examples of the polyether polyol include polyoxyethylene glycol, polyoxypropylene glycol, polyoxytetramethylene glycol, polyoxy-1,2-butylene glycol, a polyoxyethylene/polyoxypropylene random copolymer glycol, a polyoxyethylene/polyoxypropylene block copolymer glycol, a polyoxyethylene/polyoxytetramethylene random copolymer glycol, and a polyoxyethylene/polyoxytetramethylene block copolymer glycol. One type thereof may be used on its own or two or more types may be used in combination.

Examples of the polyester polyol include a condensation-based polyester polyol, that is, a diol having a repeating polyester segment obtained by a polycondensation reaction between a polyol compound (e.g. a glycol compound) and a dicarboxylic acid compound. Examples of such a diol include an adipic acid ester-based diol such as poly(ethylene glycol adipate)diol, poly(diethylene glycol adipate)diol, poly(propylene glycol adipate)diol, poly(1,4-butane glycol adipate)diol, poly(1,6-hexane glycol adipate)diol, poly(2-methylpropane glycol adipate)diol, poly(3-methyl-1,5-pentane glycol adipate)diol, poly(neopentyl glycol adipate)diol, poly(1,9-nonane glycol adipate)diol, poly(2-methyloctane glycol adipate)diol, polycaprolactonediol, and poly(β-methyl-γ-valerolactone)diol. Examples of the dicarboxylic acid compound forming the polyester segment include, in addition to adipic acid, succinic acid, glutaric acid, azelaic acid, sebacic acid, maleic acid, terephthalic acid, isophthalic acid, and 1,5-naphthalenedicarboxylic acid.

As shown in the examples above, the polyester segment is generally formed by a polycondensation reaction between a single type of diol compound and a single type of dicarboxylic acid compound. However, it is also possible to form a polyester segment by polycondensation using a plurality of types of either one or both compounds and mixing at any proportions. As the polyester polyol, in addition to the condensation-type polyester polyol, a lactone-based polyester polyol or a polyester polycarbonate polyol may be used, and one type thereof may be used on its own, or two or more types may be used in combination.

Examples of the polyester polycarbonate polyol include a polymer obtainable by allowing a polyol component, a polycarboxylic acid component and a carbonate compound to simultaneously react; a polymer obtainable by allowing a polyester polyol and a polycarbonate polyol that have been synthesized in advance to react with a carbonate compound; and a polymer obtainable by allowing a polyester polyol and a polycarbonate polyol that have been synthesized in advance to react with a polyol component and a polycarboxylic acid component.

Examples of the polycarbonate polyol include those obtained by a reaction between a polyol component and a carbonate compound such as a dialkyl carbonate, an alkylene carbonate, or a diaryl carbonate.

Examples of the polyol component forming the polycarbonate polyol include those usually used in the production of a polycarbonate polyol, for example, an aliphatic diol having 2 to 15 carbons such as ethylene glycol, diethylene glycol, triethylene glycol, propylene glycol, 1,3-propanediol, 2-methyl-1,3-propanediol, 2,2-diethyl-1,3-propanediol, 1,3-butanediol, 1,4-butanediol, 2-methyl-1,4-butanediol, neopentyl glycol, 1,5-pentanediol, 3-methyl-1,5-pentanediol, 1,6-hexanediol, 1,7-heptanediol, 1,8-octanediol, 2-methyl-1,8-octanediol, 2,7-dimethyl-1,8-octanediol, 1,9-nonanediol, 2-methyl-1,9-nonanediol, 2,8-dimethyl-1,9-nonanediol, or 1,10-decanediol; an alicyclic diol such as 1,4-cyclohexanediol, cyclohexanedimethanol, or cyclooctanedimethanol; an aromatic diol such as 1,4-bis(β-hydroxyethoxy)benzene; and a polyhydric alcohol having three or more hydroxy groups per molecule such as trimethylolpropane, trimethylolethane, glycerol, 1,2,6-hexanetriol, pentaerythritol, or diglycerol. When producing a polycarbonate polyol, with regard to these polyol components, one type thereof may be used or two or more types thereof may be used in combination.

Among them, when producing the polycarbonate polyol, it is preferable to use as the polyol component an aliphatic diol having 5 to 12 carbons and having a methyl group as a side chain, such as 2-methyl-1,4-butanediol, 3-methyl-1,5-pentanediol, 2-methyl-1,8-octanediol, 2,7-dimethyl-1,8-octanediol, 2-methyl-1,9-nonanediol, or 2,8-dimethyl-1,9-nonanediol. In particular, it is preferable to use such an aliphatic diol having 5 to 12 carbons and having a methyl group as a side chain at a proportion of at least 30 mole % of the total polyol components used in the production of the polyester polyol, and more preferably at least 50 mole % of the total polyol components.

Examples of the dialkyl carbonate include dimethyl carbonate and diethyl carbonate, examples of the alkylene carbonate include ethylene carbonate, and examples of the diary) carbonate include diphenyl carbonate.

The polycarbonate polyol is preferably a polycarbonate diol represented by Formula (1-1) below.

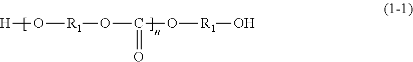

In Formula (1-1), the R₁s independently denote a straight-chain, branched, and/or cyclic hydrocarbon group having 3 to 50 carbons, which may contain an oxygen atom, etc. (at least one type of atom selected from the group consisting of nitrogen, sulfur, and oxygen) in a carbon skeleton, and R₁ may be a single component or comprise a plurality of components. n is preferably an integer of 1 to 500.

The ‘hydrocarbon group’ in R₁ is a saturated or unsaturated hydrocarbon group.

The ‘carbon skeleton’ in R₁ means a structural part having 3 to 50 carbons forming the hydrocarbon group, and the term ‘which may contain an oxygen atom, etc. in a carbon skeleton’ means a structure in which an oxygen atom, etc. is inserted into a carbon-carbon bond of a main chain or a side chain. Furthermore, it may be a substituent having an oxygen atom, etc., bonded to a carbon atom in a main chain or a side chain.

Examples of the straight-chain hydrocarbon group in R₁ include a hydrocarbon group derived from a straight-chain aliphatic diol having 3 to 50 carbons such as 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,16-hexadecanediol, or 1,20-eicosanediol.

Examples of the branched hydrocarbon group in R₁ include a hydrocarbon group derived from a branched aliphatic diol having 3 to 30 carbons such as 2-methyl-1,3-propanediol, 2-ethyl-1,3-propanediol, neopentyl glycol, 2,2-diethyl-1,3-propanediol, 2-methyl-2-propyl-1,3-propanediol, 2-butyl-2-ethyl-1,3-propanediol, 2,2-dibutyl-1,3-propanediol, 1,2-butanediol, 2-ethyl-1,4-butanediol, 2-isopropyl-1,4-butanediol, 2,3-dimethyl-1,4-butanediol, 2,3-diethyl-1,4-butanediol, 3,3-dimethyl-1,2-butanediol, pinacol, 1,2-pentanediol, 1,3-pentanediol, 2,3-pentanediol, 2-methyl-2,4-pentanediol, 3-methyl-1,5-pentanediol, 2-ethyl-1,5-pentanediol, 3-ethyl-1,5-pentanediol, 2-isopropyl-1,5-pentanediol, 3-isopropyl-1,5-pentanediol, 2,4-dimethyl-1,5-pentanediol, 2,4-diethyl-1,5-pentanediol, 2,3-dimethyl-1,5-pentanediol, 2,2,3-trimethyl-1,3-pentanediol, 1,2-hexanediol, 1,3-hexanediol, 1,4-hexanediol, 2,5-hexanediol, 2-ethyl-1,6-hexanediol, 2-ethyl-1,3-hexanediol, 2-isopropyl-1,6-hexanediol, 2,4-diethyl-1,6-hexanediol, 2,5-dimethyl-2,5-hexanediol, 2-methyl-1,8-octanediol, 2-ethyl-1,8-octanediol, 2,6-dimethyl-1,8-octanediol, 1,2-decanediol, or 8,13-dimethyl-1,20-eicosanediol.

Examples of the cyclic hydrocarbon group in R₁ include a hydrocarbon group derived from a cyclic aliphatic diol or an aromatic diol having 3 to 30 carbons such as 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, m-xylene-α,α′-diol, p-xylene-α,α′-diol, 2,2-bis(4-hydroxycyclohexyl)propane, 2,2-bis(4-hydroxyphenyl)propane, or dimer diol.

A hydrocarbon group derived from a straight-chain aliphatic diol having 3 to 50 carbons is explained as an example: in the present invention, the ‘hydrocarbon group derived from a straight-chain aliphatic diol having 3 to 50 carbons’ means a group which is a partial structure, excluding the diol hydroxy groups, of the straight-chain aliphatic diol having 3 to 50 carbons.

Examples of the hydrocarbon group containing at least one type of atom selected from the group consisting of nitrogen, sulfur, and oxygen in R₁ include a hydrocarbon group derived from diethylene glycol, triethylene glycol, tetraethylene glycol, glycerol, 1,2,6-hexanetriol, trimethylolethane, trimethylolpropane, pentaerythritol, dihydroxyacetone, 1,4:3,6-dianhydroglucitol, diethanolamine, N-methyl di ethanol amine, dihydroxyethylacetamide, 2,2′-dithiodiethanol, or 2,5-dihydroxy-1,4-dithiane, and a group represented by Formula (1-2) below.

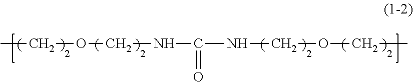

A polycarbonate diol may be produced by for example a conventionally known method as described in JP-B-5-29648, and specifically it may be produced by an ester exchange reaction between a diol and a carbonic acid ester.

In Formula (1-1) above, from the viewpoint of solvent resistance, R₁ preferably contains at least one ether bond, and from the viewpoint of solvent resistance and durability, R₁ more preferably contains a group derived from diethylene glycol (group represented by —(CH₂)₂—O—(CH₂)₂—), and R₁ is yet more preferably a group derived from diethylene glycol.

Examples of the polyether polyester copolymer polyol include a copolymer having a structure in which a repeating unit forming a molecular chain of the polyether polyol and a repeating unit forming a molecular chain of the polyester polyol are bonded as blocks or randomly. With regard to the polyether polyester copolymer polyol, one type thereof may be used on its own or two or more types may be used in combination.

Examples of the polyisocyanate compound used in the method of (i) and (ii) include a diisocyanate compound such as tolylene diisocyanate, xylylene diisocyanate, hexamethylene diisocyanate, trimethylhexamethylene diisocyanate, isophorone diisocyanate, diphenylmethane diisocyanate, dicyclohexylmethane diisocyanate, tetramethylxylylene diisocyanate, naphthalene diisocyanate, p-phenylene diisocyanate, cyclohexylene diisocyanate, lysine diisocyanate, or triphenylmethane diisocyanate; and a triisocyanate compound such as triphenylmethane triisocyanate, 1-methylbenzene-2,4,6-triisocyanate, naphthalene-1,3,7-triisocyanate, or biphenyl-2,4,4′-triisocyanate. One type thereof may be used on its own or two or more types may be used in combination.

Examples of the compound having an ethylenically unsaturated group and an active hydrogen in the molecule used in method (i) above include hydroxypropyl(meth)acrylate, hydroxyethyl(meth)acrylate, polypropylene glycol mono(meth)acrylate, polyethylene glycol mono(meth)acrylate, glycerol mono(meth)acrylate, and glycerol di(meth)acrylate.

Examples of the compound having an isocyanate group and an ethylenically unsaturated group in the molecule used in method (ii) above include (meth)acryloyloxyethyl isocyanate.

A compound that can react with a polyurethane to add a (meth)acrylic group such as the ‘compound having an ethylenically unsaturated group and an active hydrogen in the molecule’ or the ‘compound having an isocyanate group and an ethylenically unsaturated group in the molecule’ may be called a ‘(meth)acrylating agent’ in the present embodiment.

In the present specification, a polyurethane prepolymer in which a polyol structure is formed from a polyether segment is also called a ‘polyether-based polyurethane prepolymer’, a polyurethane prepolymer formed from a polyester is also called a ‘polyester-based polyurethane prepolymer’, and a polyurethane prepolymer formed from a polyether segment and a polyester segment is also called a ‘polyether polyester-based polyurethane prepolymer’.

Among them, from the viewpoint of exhibition of high flexibility and durability of a flexographic printing plate produced using the resin composition for laser engraving of the present embodiment, Component A desirably comprises a polyester-based polyurethane.

The polyester-based polyurethane improves the storage stability of a relief plate due to its polyester skeleton.

The content of Component A in the resin composition for laser engraving of the present invention is preferably 20 mass % to 95 mass %, more preferably 30 mass % to 90 mass %, and yet more preferably 40 mass % to 80 mass %, relative to the total mass of the solids content. ‘Solids content’ means components, excluding volatile components such as a solvent, in the resin composition for laser engraving.

If the content of Component A is in the range described above, printing durability improves, which is preferable.

### (Component B) Compound Having at Least Two Isocyanate Groups in Molecule

The resin composition for laser engraving of the present invention comprises (Component B) a compound having at least two isocyanate groups in the molecule. Due to Component B and Component C, which is described later, being contained, a crosslinked structure is formed, and a relief printing plate precursor and relief printing plate having excellent engraving sensitivity, rinsing properties, and ink transfer properties and suppressed film surface tackiness are obtained.

Component B preferably has a molecular weight (when there is a distribution, a number-average molecular weight) of no greater than 4,500, more preferably 100 to 4,000, and yet more preferably 150 to 2,000. It is preferable for the molecular weight to be in this range since the engraving residue rinsing properties are good.

Furthermore, Component B preferably does not contain an ethylenically unsaturated group in the molecule. It also preferably does not contain an active hydrogen in the molecule.

As component B, any one of (Component B-1) a compound having two isocyanate groups in the molecule and (Component B-2) a compound having more than two isocyanate groups in the molecule (also called an ‘isocyanate compound having an average number fn of isocyanate groups of greater than 2’) may be used, but it is preferably Component B-2. Each thereof is explained below.

### (Component B-1) Compound Having Two Isocyanate Groups in Molecule

In the present invention, (Component B-1) a compound having two isocyanate groups in the molecule (diisocyanate compound) may be used as Component B.

Examples of Component B-1 include an aliphatic diisocyanate compound, an alicyclic diisocyanate compound, an aromatic-aliphatic diisocyanate compound, and an aromatic diisocyanate compound.

Examples of the aliphatic diisocyanate compound include 1,3-trimethylene diisocyanate, 1,4-tetramethylene diisocyanate, 1,3-pentamethylene diisocyanate, 1,5-pentamethylene diisocyanate, 1,6-hexamethylene diisocyanate, 1,2-propylene diisocyanate, 1,2-butylene diisocyanate, 2,3-butylene diisocyanate, 1,3-butylene diisocyanate, 2-methyl-1,5-pentamethylene diisocyanate, 3-methyl-1,5-pentamethylene diisocyanate, 2,4,4-trimethyl-1,6-hexamethylene diisocyanate, 2,2,4-trimethyl-1,6-hexamethylene diisocyanate, 2,6-diisocyanate methyl caproate, and lysine diisocyanate.

Examples of the alicyclic diisocyanate compound include 1,3-cyclopentane diisocyanate, 1,4-cyclohexane diisocyanate, 1,3-cyclohexane diisocyanate, 3-isocyanatomethyl-3,5,5-trimethylcyclohexyl isocyanate, 4,4′-methylenebis(cyclohexyl isocyanate), methyl-2,4-cyclohexane diisocyanate, methyl-2,6-cyclohexane diisocyanate, 1,3-bis(isocyanatomethyl)cyclohexane, 1,4-bis(isocyanatomethyl)cyclohexane, isophorone diisocyanate, and norbornane diisocyanate.

Examples of the aromatic-aliphatic diisocyanate compound include 1,3-xylene diisocyanate, 1,4-xylene diisocyanate, ω,ω′-diisocyanato-1,4-diethylbenzene, 1,3-bis(1-isocyanato-1-methylethyl)benzene, 1,4-bis(1-isocyanato-1-methylethyl)benzene, and 1,3-bis(α,α-dimethylisocyanatomethyl)benzene.

Examples of the aromatic diisocyanate compound include m-phenylene diisocyanate, p-phenylene diisocyanate, 2,4-tolylene diisocyanate, 2,6-tolylene diisocyanate, 1,4-naphthylene diisocyanate, 1,5-naphthylene diisocyanate, 4,4′-diphenyl diisocyanate, 4,4′-diphenylmethane diisocyanate, 2,4′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, and 3,3′-dimethoxydiphenyl-4,4′-diisocyanate.

The diisocyanate compounds described above may be used singly or in combination.

(Component B-2) Isocyanate Compound Having Average Number of Isocyanato Groups, fn, of Greater than 2

The resin composition for laser engraving of the present invention comprises as Component B (Component B-2) an isocyanate compound having an average number of isocyanato groups, fn, of greater than 2.

The average number of isocyanato groups, fn, of Component B-2 is not particularly limited if it is greater than 2, but the average number is preferably greater than 2 and equal to or less than 4, more preferably 2.2 to 3.8, and even more preferably 2.4 to 3.6. If the average number of isocyanato groups, fn, is greater than 2, high crosslinking density can be obtained. As long as the average number of isocyanato groups, fn, is in the range described above, the isocyanate compound may be a single isocyanate compound, or may include any unreacted isocyanate compound that is produced as a side product at the time of the production of the isocyanate compound. The average number of isocyanato groups, fn, can be determined by the following formula:

Average number of isocyanato groups=(Number average molecular weight)×(Isocyanato group mass %)/(Formula weight of isocyanato (42)×100)

Component B-2 used in the present invention preferably includes at least one chemical structure selected from the group consisting of isocyanurate, uretdione, allophanate, and biuret.

Examples of Component B-2 having an isocyanurate structure include an isocyanurate trimer, and an isocyanurate pentamer, and oligomers such as an isocyanurate heptamer, a nonamer and higher oligomers are also available.

An isocyanurate trimer is a polyisocyanate having isocyanurate groups, which is formed from three molecules of a diisocyanate monomer, and the isocvanurate trimer is represented by Formula (2) below.

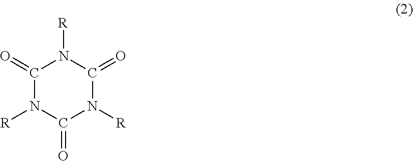

In Formula (2), R denotes a diisocyanate monomer residue.

An isocyanurate pentamer is a polyisocyanate having an isocyanurate structure, which is formed from six molecules of a diisocyanate monomer, and the isocyanurate pentamer is represented by Formula (3) below.

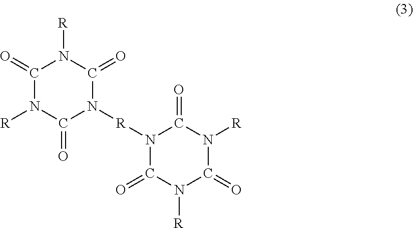

In Formula (3), R denotes a diisocyanate monomer residue.

A compound having an allophanate structure is formed from a hydroxyl group of a monoalcohol and an isocyanato group, and is represented by Formula (4) below.

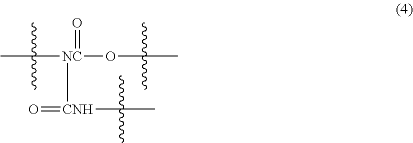

(In Formula (4), a wavy portion denotes a bonding position to another structure.)

An example of a compound having a uretdione structure may be a uretdione dimer. A uretdione dimer is a compound having a uretdione group, which is formed from two molecules of a diisocyanate monomer, and the uretdione dimer is represented by Formula (5) below.

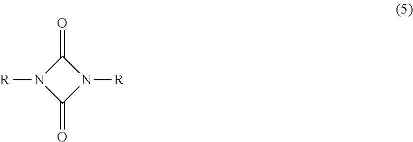

In Formula (5), R denotes a diisocyanate monomer residue.

A compound having a biuret structure is formed from an urea and an isocyanato group, and is represented by Formula (6) below.

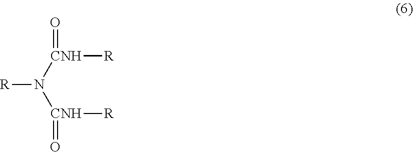

In Formula (6), R denotes a diisocyanate monomer residue.

As Component B-2, a conventionally known isocyanate compound having an average number of isocyanato groups, fn, of greater than 2 can be used. Also, Component B-2 can also be produced by using various isocyanate compounds as raw materials. As the isocyanate compounds that may be used as raw materials, diisocyanate compounds or other polyisocyanate compounds can be used. Examples of the diisocyanate compounds that can be used include an aliphatic diisocyanate compound, an alicyclic diisocyanate compound, an aromatic-aliphatic diisocyanate compound, and an aromatic diisocyanate compound which are described above in Component B-1.

As a starting material isocyanate for Component B-2, the isocyanate compounds cited above as examples may be used on their own or in combination.

Preferred examples of the raw material isocyanate compound for Component B-2 include tolylene diisocyanate (hereinafter, abbreviated to TDI), diphenylmethane diisocyanate (hereinafter, abbreviated to MDI), hexamethylene diisocyanate (hereinafter, abbreviated to HDI), isophorone diisocyanate (hereinafter, abbreviated to IPDI), diphenylmethane diisocyanate including a diphenylmethane diisocyanate dimer compound, carbodiimide-modified diphenylmethane diisocyanate, and uretdione ring- and isocyanurate ring-containing modification products of hexamethylene diisocyanate, and these can be used singly or in combination. From the viewpoint of weather resistance, HDI or IPDI is more preferable, and from the viewpoint of mechanical characteristics, MDI or TDI is more preferable. Furthermore, from the viewpoint of the abundance of the types of isocyanate, HDI is even more preferable.

Examples of Component B-2 that is produced from the isocyanate compounds that are used as raw materials include isocyanurate ring-containing modification products, uretdione ring-containing modification products, allophanate-containing modification products, and biuret-containing modification products of hexamethylene diisocyanate. These can be used singly or in combination. From the viewpoint of solvent resistance, isocyanurate ring-containing modification products are preferable.

As Component B-2, commercially available products can also be employed, and examples include Duranate TPA-100, Duranate TKA-100, Duranate TLA-100, Duranate TSA-100, Duranate TSE-100, Duranate TSS-100, Duranate TSR-100, and Duranate 24A-100 (all manufactured by Asahi Chemical Corp.).

With regard to Component B, one type may be used on its own or two or more types may be used in combination.

It is preferable that Component B comprises at least Component B-2, and it is more preferable that Component B is Component B-2. Due to Component B-2 being contained, higher crosslink density is obtained, which is preferable.

The content of Component B in the resin composition is preferably 5 to 70 mass % relative to the total amount of solids content excluding volatile components, more preferably 10 to 50 mass %, and yet more preferably 10 to 40 mass %.

It is preferable for the content of Component B to be in this range since the ink transfer properties are good.

### (Component C) Compound Having at Least Two Active Hydrogens in Molecule

The resin composition for laser engraving of the present invention comprises (Component C) a compound having at least two active hydrogens in the molecule.

The active hydrogen referred to here means a hydrogen atom in —OH, —SH, —NH—, —NH₂, —COOH, etc., and means a hydrogen atom that has reactivity toward an isocyanate group of Component B. Among them, the active hydrogen is preferably a hydrogen atom in —OH, —NH—, or —NH₂.

As long as Component C has at least two active hydrogens per molecule, the upper limit is not particularly limited, but the number is preferably 2 to 6, more preferably 2 to 4, yet more preferably 2 to 3, and particularly preferably 2. When the number of active hydrogens per molecule of Component C is less than two, it cannot fully react with Component B. It is preferable for the number of active hydrogens per molecule of Component C to be no greater than six since the rinsing properties of a printing plate precursor that is obtained are excellent.

Examples of Component C include (Component C-1) a compound having a siloxane bond in the molecule and having at least two active hydrogens and (Component C-2) a compound having at least two active hydrogens but not having a siloxane bond in the molecule.

Component C preferably has a molecular weight (when there is a molecular weight distribution, the number-average molecular weight) of no greater than 30,000, more preferably 100 to 20,000, and yet more preferably 150 to 10,000. It is preferable for the molecular weight to be in this range since a printing plate that is resistant to swelling with a solvent ink is obtained. Furthermore, Component C preferably does not contain an ethylenically unsaturated group in the molecule. Moreover, Component C preferably does not contain an isocyanate group in the molecule.

Each thereof is explained below.

### (Component C-1) Compound Having Siloxane Bond in the Molecule and Having at Least Two Active Hydrogens

Component C-1 essentially contains a siloxane bond in the molecule.

### <Siloxane Bond>

The siloxane bond is now explained. The siloxane bond referred to here means a molecular structure in which silicon (Si) and oxygen (O) are bonded in turn.

Although a detailed mechanism for the excellent solvent ink suitability of a relief printing plate obtained using the resin composition of the present invention is not clear, it is surmised by the present inventor that due to a siloxane bond being stably present in Component C-1, its affinity for an ink is low compared with that of a siloxane bond present in an additive, and the solvent ink suitability is therefore improved.

Component C-1 above is preferably one obtained from a silicone compound having an average composition represented by Formula (1) below.

RₚQᵣXₛSiO_{(4-p-r-s)/2} (1)

In Formula (A), R represents one kind or two or more kinds of hydrocarbon groups selected from the group consisting of a linear or branched alkyl group having 1 to 30 carbon atoms, a cycloalkyl group having 5 to 20 carbon atoms, an alkyl group having 1 to 30 carbon atoms (carbon number before substitution) substituted with an alkoxy group having 1 to 20 carbon atoms or aryl group having 6 to 20 carbon atoms, an aryl group having 6 to 20 carbon atoms substituted with a halogen atom, an alkoxycarbonyl group having 2 to 30 carbon atoms, a monovalent group containing a carboxyl group or a salt thereof, a monovalent group containing a sulfo group or a salt thereof, and a polyoxyalkylene group; Q and X each independently represent one kind or two or more kinds of a hydrogen atom or hydrocarbon groups selected from the group consisting of a linear or branched alkyl group having 1 to 30 carbon atoms, a cycloalkyl group having 5 to 20 carbon atoms, an alkyl group having 1 to 30 carbon atoms substituted with an alkoxy group or aryl group having 1 to 20 carbon atoms, an aryl group having 6 to 20 carbon atoms substituted with a halogen atom, an alkoxycarbonyl group having 2 to 30 carbon atoms, a monovalent group containing a carboxyl group or a salt thereof, a monovalent group containing a sulfo group or a salt thereof, and a polyoxyalkylene group; and p, r and s represent numbers satisfying the relations:

0<p<4,

0≦r<4,0,

0≦s<4, and

(p+r+s)<4.

In the present embodiment, in order to introduce a siloxane bond, Component C-1 may be obtained from a compound having a siloxane bond.

Examples of the compound having a siloxane bond for introducing a siloxane bond include silicone oils. Examples of the silicone oils include organopolysiloxanes having from low viscosity to high viscosity, such as dimethylpolysiloxane, methylphenylpolysiloxane, methylhydrogenpolysiloxane, and dimethylsiloxane-methylphenylsiloxane copolymers; cyclic siloxanes such as octamethylcyclotetrasiloxane, decamethylcyclopentasiloxane, dodecamethylcyclohexasiloxane, tetramethyltetrahydrogencyclotetrasiloxane, and tetramethyltetraphenylcyclotetrasiloxane; silicone rubbers such as gum-like dimethylpolysiloxane having a high degree of polymerization, and gum-like dimethylsiloxane-methylphenylsiloxane copolymers; cyclic siloxane solutions of the silicone rubber; trimethylsiloxysilicic acid; cyclic siloxane solution of trimethylsiloxysilicic acid; higher alkoxy-modified silicones such as stearoxysilicone; and higher fatty acid-modified silicones.

In the present invention, Component C-1 may also be obtained by modifying the compound having a siloxane bond.

Examples include monoamine-modified silicone oil, diamine-modified silicone oil, special amino-modified silicone oil, carbinol-modified silicone oil, mercapto-modified silicone oil, carboxy-modified silicone oil, amino-polyether-modified silicone oil, epoxy-polyether-modified silicone oil, reactive silicone oil, polyether-modified silicone oil, mercapto-modified silicone oil, phenol-modified silicone oil, silanol-modified silicon oil, side chain amino-both termini methoxy-modified silicone oil, and diol-modified silicone oil. These silicone oils having reactive hydrogens can be used.

Among the silicone oils having two or more reactive hydrogens in the molecule, both termini-modified silicone oil is preferred. Examples include both termini amino-modified silicone oil, both termini carbinol-modified silicone oil, both termini polyether-modified silicone oil, both termini mercapto-modified silicone oil, both termini carboxy-modified silicone oil, both termini phenol-modified silicone oil, and both termini silanol-modified silicone oil.

Furthermore, a single terminal-modified silicone oil or a side chain-modified silicone oil may also be used. Examples include a single terminal diol-modified silicone oil, a side chain monoamine-modified silicone oil, a side chain diamine-modified silicone oil, a side chain carbinol-modified silicone oil, a side chain carboxy-modified silicone oil, a side chain aminopolyether-modified silicone oil, and a side chain epoxy/polyether-modified silicone oil.

Among them, from the viewpoint of reactivity and ease of handling aspects such as odor and irritation, a both termini carbinol-modified silicone oil, a both termini amino-modified silicone oil, and a single terminal diol-modified silicone oil are preferable, a both termini carbinol-modified silicone oil and a single terminal diol-modified silicone oil are more preferable, and a both termini carbinol-modified silicone oil is yet more preferable.

Furthermore, the number-average molecular weight of Component C-1 is preferably at least 500 but no greater than 30,000, and more preferably at least 500 but no greater than 20,000. It is preferable for it to be in this range since solvent ink suitability due to a siloxane bond is fully exhibited, and due to it being possible to obtain flowability and compatibility between Component C-1 and Component A, the ease of handling is good. The number-average molecular weight referred to here is a value obtained by measurement using gel permeation chromatography and calculating using calibration against a polystyrene having a known molecular weight.

When a both termini-modified silicone oil is used as Component C-1, the number-average molecular weight of Component C-1 is preferably at least 500 but no greater than 10,000, more preferably at least 500 but no greater than 5,000, and yet more preferably at least 500 but no greater than 3,000.

When a single terminal-modified silicone oil and/or side chain-modified silicone oil is used as Component C-1, the number-average molecular weight of Component C-1 is preferably at least 1,000 but no greater than 30,000, and more preferably at least 10,000 but no greater than 20,000.

A commercial product may be used as Component C-1, and examples of the both termini amino-modified silicone oil include KF-8010 and X-22-161A (Shin-Etsu Chemical Co., Ltd.); examples of the both termini carbinol-modified silicone oil include X-22-160AS and KF-6003 (both from Shin-Etsu Chemical Co., Ltd.) and BY 16-004 (Dow Corning Toray); and examples of the single terminal diol-modified silicone oil include X-22-176DX and X-22-176F (both from Shin-Etsu Chemical Co., Ltd.).

### (Component C-2) Compound Having at Least Two Active Hydrogens but not Having Siloxane Bond in Molecule

The resin composition for laser engraving of the present invention preferably comprises (Component C-2) a compound having at least two active hydrogens but not having a siloxane bond in the molecule.

Since the reaction proceeds rapidly and a film having high strength is obtained, Component C-2 is preferably a compound having one or more functional groups selected from the group consisting of a primary amino group and an acid anhydride group, or a compound having two or more functional groups selected from the group consisting of a secondary amino group, a mercapto group, a carboxyl group, a phenolic hydroxyl group and a hydroxyl group, more preferably a compound having one or more functional groups selected from the group consisting of a primary amino group and an acid anhydride group, or a compound having two or more functional groups selected from the group consisting of a secondary amino group and a mercapto group, and yet more preferably a compound having one or more functional groups selected from the group consisting of a primary amino group and an acid anhydride group.

The compound having at least one primary amino group is not particularly limited, and various types thereof may be used.

Examples thereof include primary alkylamines such as butylamine, octylamine, oleylamine and 2-ethylhexylamine, primary anilines such as aniline, 4-aminoacetophenone, p-anisidine, 2-aminoanthracene and 1-naphthylamine, primary alkanolamines such as monoethanolamine, 2-ethoxyethanolamine and 2-hydroxypropanolamine, aliphatic polyamines such as hexanediamine, ethylenediamine, diethylenetriamine, triethylenetetramine, tetraethylenepentamine, m-xylenediamine and p-xylenediamine, alicyclic polyamines such as 1,3-diaminocyclohexane and isoholondiamine, polyanilines such as 1,4-phenylenediamine, 2,3-diaminonaphthalene, 2,6-diaminoanthraquinone, 2,2-bis(4-aminophenyl)hexafluoropropane, 4,4′-diaminobenzophenone and 4,4′-diaminodiphenylmethane, Mannich bases consisting of a polycondensate of polyamines, an aldehyde compound, and mono- or polyvalent phenols, and polyamidopolyamines obtained by the reaction of polyamines with polycarboxylic acid or dimer acid.

Among these, because of the suitability for forming a high degree of three dimensional crosslinking, aliphatic polyamines, alicyclic polyamines and polyanilines are preferable, and, in particular, hexanediamine, triethylenetetramine, m-xylenediamine and 4,4′-diaminodiphenylmethane are more preferable.

The compound having at least two secondary amino groups is not particularly limited, and various types thereof may be used.

Examples thereof include N,N′-dimethylethylenediamine, N,N′-diethylethylenediamine, N,N′-dibenzylethylenediamine, N,N′-diisopropylethylenediamine, 2,5-dimethylpiperazine, N,N′-dimethylcyclohexane-1,2-diamine, piperazine, homopiperazine, 2-methylpiperazine, etc.

The compound having at least one acid anhydride group is not particularly limited, and various types thereof may be used.

Usable examples thereof include acid anhydride compounds such as succinic anhydride, maleic anhydride, phthalic anhydride, hexahydrophthalic anhydride, methylhexahydrophthalic anhydride, nadic anhydride, hydrogenated nadic anhydride, trimellitic anhydride, and pyromellitic anhydride. Among these, the use of methylhexahydrophthalic anhydride is particularly preferable, which gives a cured film that shows a little curing contraction and has transparency and high strength.

The compound having at least two mercapto groups is not particularly limited, and various types thereof may be used.

Examples thereof include alkanedithiols such as 1,2-ethanedithiol, 1,3-propanedithiol, 1,4-butanedithiol, 1,5-pentanedithiol, 1,6-hexanedithiol, 1,7-heptanedithiol, 1,8-octanedithiol, 1,9-nonanedithiol, 1,10-decanedithiol, 1,12-dodecanedithiol, 2,2-dimethyl-1,3-propanedithiol, 3-methyl-1,5-pentanedithiol and 2-methyl-1,8-octanedithiol, cycloalkanedithiols such as 1,4-cyclohexanedithiol, alkanedithiols containing a hetero atom in a carbon chain such as bis(2-mercaptoethyl)ether, bis(2-mercaptoethyl)sulfide, bis(2-mercaptoethyl)disulfide and 2,2′-(ethylenedithio)diethanethiol, alkanedithiols containing a hetero atom and an alicyclic structure in a carbon chain such as 2,5-bis(mercaptomethyl)-1,4-dioxane and 2,5-bis(mercaptomethyl)-1,4-dithiane, alkanetrithiols such as 1,1,1-tris(mercaptomethyl)ethane, 2-ether-2-mercaptomethyl-1,3-propanedithiol and 1,8-mercapto-4-mercaptomethyl-3,6-thiaoctane, alkanetetrathiols such as tetrakis(mercaptomethyl)methane, 3,3′-thiobis(propane-1,2-dithiol), 2,2′-thiobis(propane-1,3-dithiol), etc.

The compound having at least two carboxyl groups is not particularly limited, and various types thereof may be used.

Examples thereof include succinic acid, maleic acid, phthalic acid, hexahydrophthalic acid, methylhexahydrophthalic acid, nadic acid, hydrogenated nadic acid, trimellitic acid, pyromellitic acid, adipic acid, sebacic acid, dodecanedicarboxylic acid, isophthalic acid, 2-methylterephthalic acid, naphthalenedicarboxylic acid, etc.

The compound having at least two phenolic hydroxyl groups is not particularly limited, and various types thereof may be used.

Examples thereof include novolac type resins such as phenolnovolac resin, cresolnovolac resin and naphtholnovolac resin; polyfunctional type phenol resins such as triphenolmethane type resin; modified phenol resins such as dicyclopentanediene-modified phenol resin and terpene-modified phenol resin; aralkyl type resins such as phenolaralkyl resin having a phenylene skeleton, phenolaralkyl resin having a biphenylene skeleton, naphtholaralkyl resin having a phenylene skeleton and naphtholaralkyl resin having a biphenylene skeleton; bisphenol compounds such as bisphenol A and bisphenol F; a sulfur atom-containing type phenol resins such as bisphenol S, etc.

As the compound having at least two hydroxyl groups, various kinds may be used, without particular limitations.

Examples thereof include ethylene glycol, diethylene glycol, propylene glycol, dipropylene glycol, trymethylene glycol, 1,4-tetramethylenediol, 1,3-tetramethylenediol, 2-methyl-1,3-trymethylenediol, 1,5-pentamethylenediol, neopentyl glycol, 1,6-hexamethylenediol, 3-methyl-1,5-pentamethylenediol, 2,4-diethyl-1,5-pentamethylenediol, glycerin, trimethylolpropane, trimethylolethane, cyclohexanediols (such as 1,4-cyclohexanediol), bisphenols (such as bisphenol A), sugar alcohols (such as xylitol and sorbitol), polyalkylene glycols such as polyethylene glycol, polypropylene glycol and polytetramethylene glycol, etc.

Furthermore, as Component C-2, a polycarbonate polyol, a polyester polyol, etc. may be used, and examples include Duranol T462 (Asahi Kasei).

Specific examples of Component C-2 include the compounds listed below, but the present invention is not limited by these compounds.

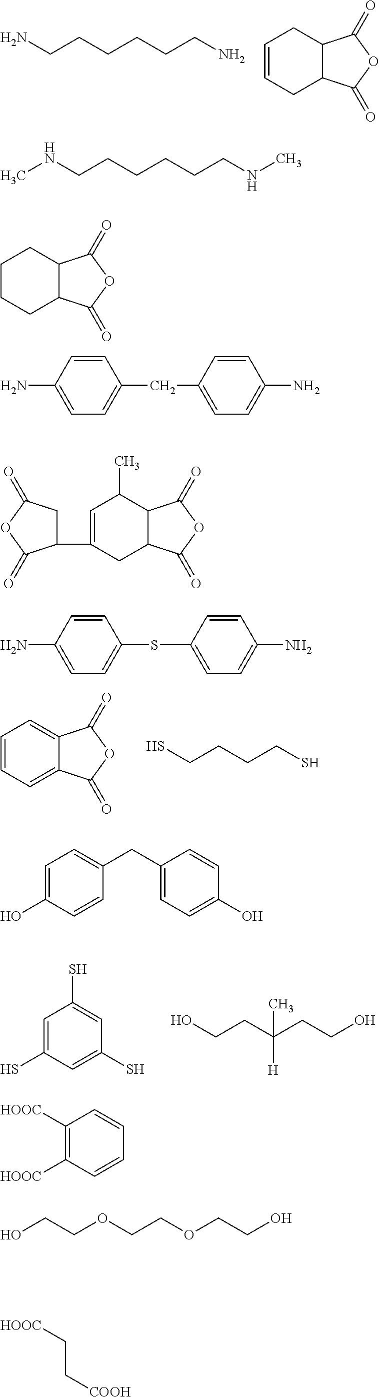

The resin composition for laser engraving of the present invention may comprise only one type of Component C or two or more types thereof in combination.

In the present invention, it is preferable that Component C comprises at least Component C-1, it is more preferable that it comprises at least two types of Component C and at least one thereof is Component C-1, and it is yet more preferable that Component C-1 and Component C-2 are used in combination.

The content of Component C is preferably 10 to 70 mass % relative to the total solids content of the resin composition, more preferably 10 to 50 mass %, and yet more preferably 10 to 40 mass %. It is preferable for the content of Component C to be in this range since the printing durability improves.

From the viewpoint of reactivity, the equivalence (molar ratio) of the isocyanate groups in Component B and the active hydrogens in Component C is preferably 70:30 to 30:70, more preferably 60:40 to 40:60, and yet more preferably 55:45 to 45:55. It is preferable to appropriately adjust the amounts of Component B and Component C added to give this range.

### (Component D) Thermopolymerization Initiator

The resin composition for laser engraving of the present invention comprises (Component D) a thermopolymerization initiator in order to accelerate the formation of cross-linking structure.

With regard to the thermopolymerization initiator, one known to a person skilled in the art may be used without any limitations. Radical polymerization initiators, which are preferred thermopolymerization initiators, are explained in detail below, but the present invention should not be construed as being limited to these descriptions.

In the present invention, preferable thermopolymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the relief printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554 (JP-A denotes a Japanese unexamined patent application publication).

Moreover, (c) organic peroxides and (l) azo compounds preferably include the following compounds.

### (c) Organic Peroxide

Preferred examples of the organic peroxide (c) as a radically polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butyldiperoxyisophthalate, and t-butylperoxybenzoate.

### (l) Azo Compounds

Preferable (l) azo compounds as a radically polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

It has been found that in the present invention the organic peroxide (c) above is preferable as a thermopolymerization initiator in the present invention from the viewpoint of the crosslinkablility of the film (relief-forming layer), and as an unexpected effect it is particularly preferable from the viewpoint of improvement of engraving sensitivity.

In the present invention, the thermopolymerization initiator may be used singly or in a combination of two or more compounds.

In the present invention, the content of Component D in the resin composition of the present invention is preferably 0.01 to 20 mass % relative to the total mass of the solids content, more preferably 0.05 to 10 mass %, and yet more preferably 0.1 to 7 mass %.

It is preferable for the content of Component D to be in this range since the printing durability is good.

The resin composition for laser engraving of the present invention comprises Component A to Component D as essential components and may comprise another component. Examples of the other component include, but are not limited to, (Component E) a photothermal conversion agent that can absorb light having a wavelength of 700 to 1,300 nm, (Component F) a compound having a hydrolyzable silyl group and/or a silanol group, (Component G) a radically polymerizable compound, (Component H) a plasticizer, (Component I) a filler, (Component J) a binder polymer, and (Component K) a solvent.

Each compound of Component E to Component K is one that is other than Component A to Component D, and compounds that, in terms of wording, correspond to Component A to Component D and also correspond to Component E to component K are considered to be Component A to Component D.

### (Component E) Photothermal Conversion Agent Capable of Absorbing Light Having a Wavelength of 700 to 1,300 nm

The resin composition for laser engraving of the present invention preferably further comprises (Component E) a photothermal conversion agent capable of absorbing light having a wavelength of 700 to 1,300 nm (hereinafter, simply called “photothermal conversion agent”). That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the relief printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific preferable examples include dyes having a maximum absorption wavelength from 700 nm to 1,300 nm, and such preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes.

In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low DBP (dibutyl phthalate) absorption and also finely divided carbon black having a large specific surface area. Preferred examples of carbon black include Printex (registered trademark) U, Printex (registered trademark) A, Spezialschwarz (registered trademark) 4 (Degussa), and #45L (Mitsubishi Chemical Corporation).

The carbon black that can be used in the present invention has preferably a dibutyl phthalate (DBP) absorption number of less than 150 mL/100 g, more preferably no greater than 100 mL/100 g, and yet more preferably no greater than 70 mL/100 g.

From the viewpoint of improving engraving sensitivity by efficiently transmitting heat generated by photothermal conversion to the surrounding polymer, etc., the carbon black is preferably a conductive carbon black having a specific surface area of at least 100 m²/g.

Component E in the resin composition for laser engraving of the present invention may be used singly or in a combination of two or more compounds.

The content of the photothermal conversion agent capable of absorbing light having a wavelength of 700 to 1,300 nm in the resin composition for laser engraving of the present invention largely depends on the size of the molecular extinction coefficient characteristic to the molecule, and is preferably 0.01 to 20 mass % relative to the total solids content of the resin composition, more preferably 0.05 to 10 mass %, and yet more preferably 0.1 to 5 mass %.

(Component F) Compound Having a Hydrolysable Silyl Group and/or Silanol Group

The resin composition for laser engraving of the present invention preferably comprises (Component F) a compound having a hydrolysable silyl group and/or silanol group.

The ‘hydrolyzable silyl group’ of Component F used in the resin composition for laser engraving of the present invention is a silyl group that is hydrolyzable; examples of hydrolyzable groups include an alkoxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or silanol group is preferably one represented by Formula (A) below.

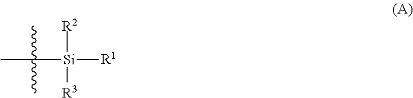

In Formula (A) above, R¹ to R³ denote independently a hydrolyzable group selected from the group consisting of an alkoxy group, an aryloxy group, a mercapto group, a halogen atom, an amide group, an acetoxy group, an amino group, and an isopropenoxy group, or a hydroxy group, a hydrogen atom, or a monovalent organic group. At least one of R¹ to R³ denotes a hydrolyzable group selected from the group consisting of an alkoxy group, an aryloxy group, a mercapto group, a halogen atom, an amide group, an acetoxy group, an amino group, and an isopropenoxy group, or a hydroxy group. A wavy portion denotes a bonding position to another structure.

When R¹ to R³ denote a monovalent organic group, from the viewpoint that solubility in various types of organic solvents can be given, an organic group is preferably an alkyl group having 1 to 30 carbon atoms.

In Formula (A) above, the hydrolyzable group bonded to the silicon atom is particularly preferably an alkoxy group or a halogen atom.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms.

Furthermore, examples of the halogen atom include a F atom, a Cl atom, a Br atom, and a I atom, and from the viewpoint of ease of synthesis and stability it is preferably a Cl atom or a Br atom, and more preferably a Cl atom.

Component F is preferably a compound having one or more groups represented by Formula (A) above, and more preferably a compound having two or more. As Component F compound having two or more hydrolyzable silyl groups is particularly preferably used.

Moreover Component F is preferably a compound having in the molecule two or more silicon atoms. The number of silicon atoms in the compound is preferably at least 2 but no greater than 6, and most preferably 2 or 3.

A range of 1 to 3 of the hydrolyzable groups may bond to one silicon atom, and the total number of hydrolyzable groups in Formula (A) is preferably in a range of 2 or 3. It is particularly preferable that three hydrolyzable groups are bonded to a silicon atom. When two or more hydrolyzable groups are bonded to a silicon atom, they may be identical to or different from each other.

Examples of the alkoxy group include a methoxy group, an ethoxy group, a propoxy group, an isopropoxy group, a butoxy group, a tert-butoxy group, and a benzyloxy group. Examples of the alkoxysilyl group having an alkoxy group bonded thereto include a trialkoxysilyl group such as a trimethoxysilyl group, a triethoxysilyl group, or a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group. A plurality of each of these alkoxy groups may be used in combination, or a plurality of different alkoxy groups may be used in combination.

Examples of the aryloxy group include phenoxy group. Examples of the aryloxysilyl group having an aryloxy group bonded thereto include a triarylsilyl group such as a triphenylsilyl group.

Preferred examples of Component F in the present invention include compounds in which a plurality of groups represented by Formula (A) above are bonded via a linking group, and from the viewpoint of the effects, such a linking group is preferably a linking group having a sulfide group, an imino group or a ureylene group.

The representative synthetic method of Component F containing a linking group having a sulfide group, an imino group or ureylene group is shown below.

<Synthetic Method for Compound Having Hydrolyzable Silyl Group and/or Silanol Group and Having Sulfide Group as Linking Group>

A synthetic method for a Component F having a sulfide group as a linking group (hereinafter, called as appropriate a ‘sulfide linking group-containing Component F’) is not particularly limited, but specific examples thereof include reaction of a Component F having a halogenated hydrocarbon group with an alkali metal sulfide, reaction of a Component F having a mercapto group with a halogenated hydrocarbon, reaction of a Component F having a mercapto group with a Component F having a halogenated hydrocarbon group, reaction of a Component F having a halogenated hydrocarbon group with a mercaptan, reaction of a Component F having an ethylenically unsaturated double bond with a mercaptan, reaction of a Component F having an ethylenically unsaturated double bond with a Component F having a mercapto group, reaction of a compound having an ethylenically unsaturated double bond with a Component F having a mercapto group, reaction of a ketone with a Component F having a mercapto group, reaction of a diazonium salt with a Component F having a mercapto group, reaction of a Component F having a mercapto group with an oxirane, reaction of a Component F having a mercapto group with a Component F having an oxirane group, reaction of a mercaptan with a Component F having an oxirane group, and reaction of a Component F having a mercapto group with an aziridine.

<Synthetic Method for Compound Having Hydrolyzable Silyl Group and/or Silanol Group and Having Imino Group as Linking Group>

A synthetic method for a Component F having an imino group as a linking group (hereinafter, called as appropriate an ‘imino linking group-containing Component F’) is not particularly limited, but specific examples include reaction of a Component F having an amino group with a halogenated hydrocarbon, reaction of a Component F having an amino group with a Component F having a halogenated hydrocarbon group, reaction of a Component F having a halogenated hydrocarbon group with an amine, reaction of a Component F having an amino group with an oxirane, reaction of a Component F having an amino group with a Component F having an oxirane group, reaction of an amine with a Component F having an oxirane group, reaction of a Component F having an amino group with an aziridine, reaction of a Component F having an ethylenically unsaturated double bond with an amine, reaction of a Component F having an ethylenically unsaturated double bond with a Component F having an amino group, reaction of a compound having an ethylenically unsaturated double bond with a Component F having an amino group, reaction of a compound having an acetylenically unsaturated triple bond with a Component F having an amino group, reaction of a Component F having an imine-based unsaturated double bond with an organic alkali metal compound, reaction of a Component F having an imine-based unsaturated double bond with an organic alkaline earth metal compound, and reaction of a carbonyl compound with a Component F having an amino group.

<Synthetic Method for Compound Having Hydrolyzable Silyl Group and/or Silanol Group and Having Ureylene Group as Linking Group>

A synthetic method for a Component F having an ureylene group (hereinafter, called as appropriate a ‘ureylene linking group-containing Component F’) as a linking group is not particularly limited, but specific examples include synthetic methods such as reaction of a Component F having an amino group with an isocyanate ester, reaction of a Component F having an amino group with a Component F having an isocyanate ester, and reaction of an amine with a Component F having an isocyanate ester.

A silane coupling agent is preferably used as Component F in the preset invention.

Hereinafter, the silane coupling agent suitable as Component F in the present invention will be described.

In the present invention, the functional group in which an alkoxy group or a halogeno group (halogen atom) is directly bonded to at least one Si atom is called a silane coupling group, and the compound which has one or more silane coupling groups in the molecule is also called a silane coupling agent. The silane coupling group is preferable in which two or more alkoxy groups or halogen atoms are directly bonded to a Si atom, and the silane coupling group is more preferable in which three or more alkoxy groups or halogen atoms are directly bonded to a Si atom.

In the silane coupling agent which is a preferable aspect in the present invention, as a functional group directly bonded to the Si atom, it is indispensable to have at least one or more functional groups selected from an alkoxy group and a halogen atom, and one having an alkoxy group is preferable from the viewpoint of ease of handling of the compound.

Here, with regard to the alkoxy group from the viewpoint of rinsing properties and printing durability, an alkoxy group having 1 to 30 carbon atoms is preferable, an alkoxy group having 1 to 15 carbon atoms is more preferable, and an alkoxy group having 1 to 5 carbon atoms is yet more preferable.

Moreover, as a halogen atom, an F atom, a Cl atom, a Br atom, and an I atom are included; from the viewpoint of ease of synthesis and stability, a Cl atom and a Br atom are preferable, and a Cl atom is more preferable.

The silane coupling agent in the present invention preferably contains at least 1 but no greater than 10 of above silane coupling groups within the molecule from the viewpoint of favorably maintaining a balance of the degree of crosslinking of the film and flexibility, more preferably contains at least 1 but no greater than 5, and particularly preferably contains at least 2 but no greater than 4.

When there are two or more of silane coupling groups, it is preferable that silane coupling groups are connected with the linking group each other. As the linking group includes at least a divalent organic group which may have substituents such as a hetero atom and hydrocarbons, from the viewpoint of high engraving sensitivity, an aspect containing hetero atoms (N, S, O) is preferable, and a linking group containing an S atom is particularly preferable.

From these viewpoints, as the silane coupling agent in the present invention, a compound that having in the molecule two silane coupling groups in which the methoxy group or ethoxy group, particularly a methoxy group is bonded to a Si atom as an alkoxy group and these silane coupling groups are bonded through an alkylene group containing a hetero atom (particularly preferably a S atom) is preferable. More specifically, one having a linking group containing a sulfide group is preferable.

Moreover, as another preferred aspect of the linking group connecting together silane coupling groups, a linking group having an oxyalkylene group is included. Since the linking group contains an oxyalkylene group, rinsing properties of engraving residue after laser engraving are improved. As the oxyalkylene group, an oxyethylene group is preferable, and a polyoxyethylene chain in which a plurality of oxyethylene groups are connected is more preferable. The total number of oxyethylene groups in the polyoxyethylene chain is preferably 2 to 50, more preferably 3 to 30, particularly preferably 4 to 15.

Specific examples of the silane coupling agent that can be used in the present invention are shown below. Examples thereof include β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane. Other than the above, the compounds shown below can be cited as preferred examples, but the present invention should not be construed as being limited thereto.

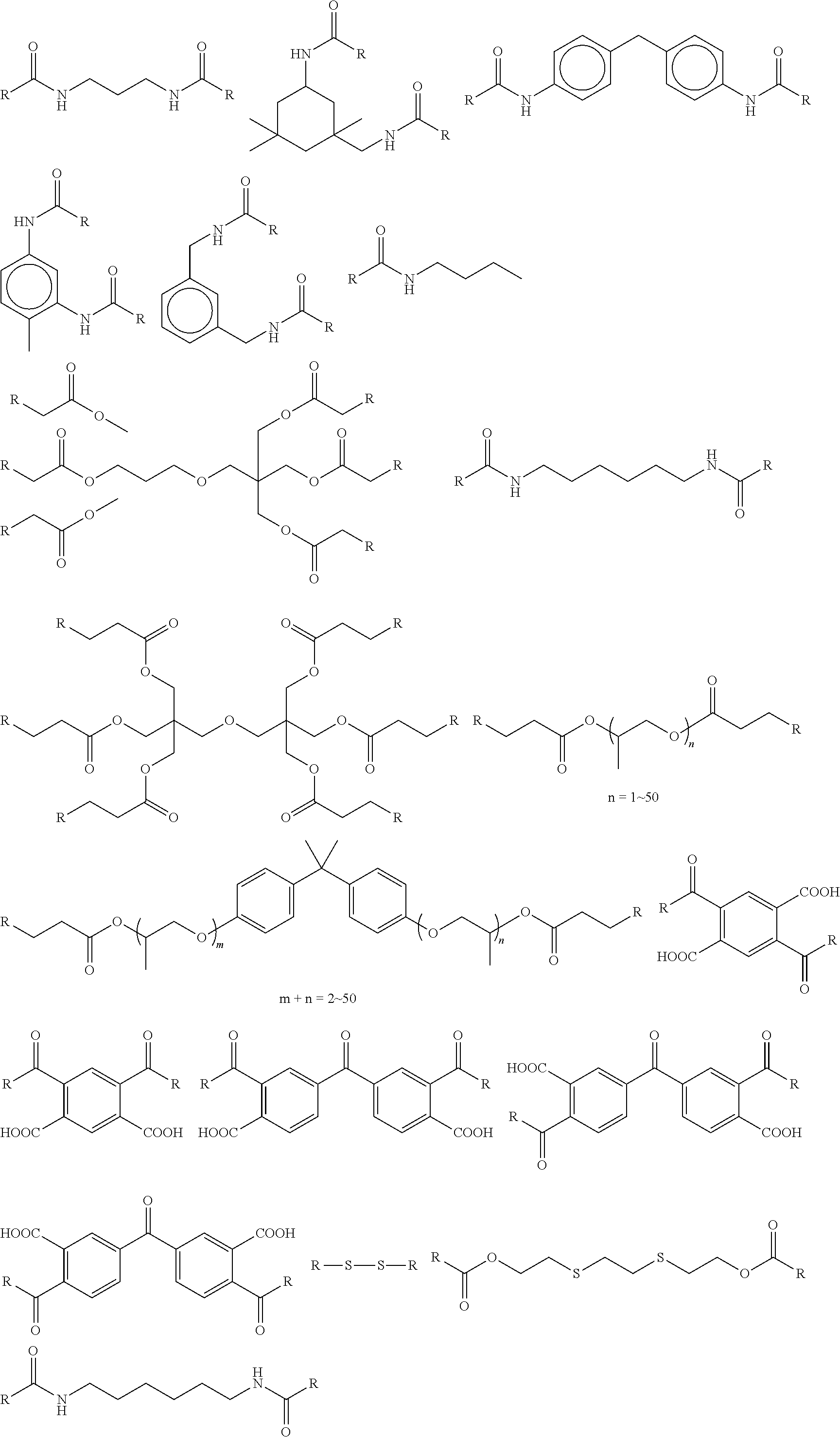

In each of the formulae above, R denotes a partial structure selected from the structures below. When a plurality of Rs and R¹s are present in the molecule, they may be identical to or different from each other, and are preferably identical to each other in terms of synthetic suitability. Et in the chemical formulae below is an ethyl group, and Me is a methyl group.

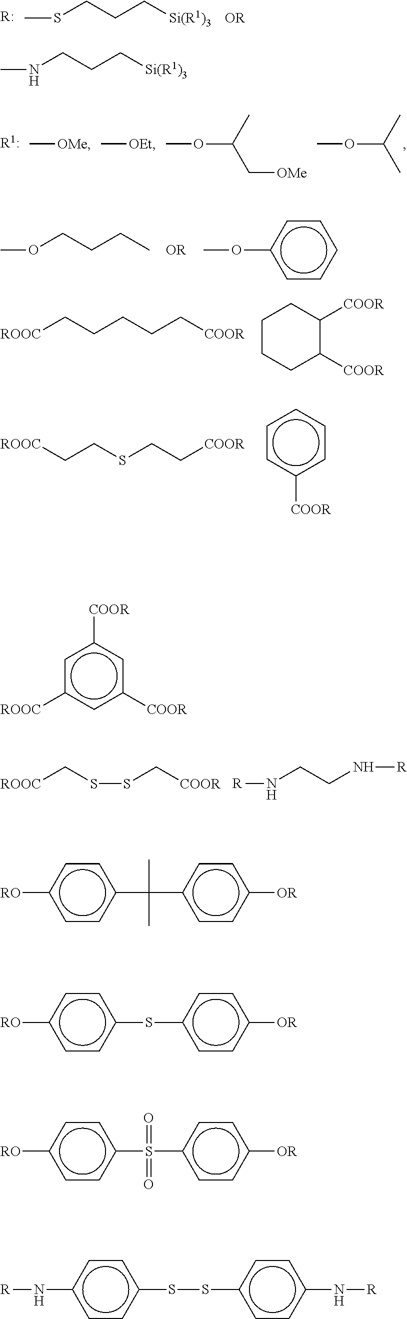

In each of the formulae above, R denotes a partial structure selected from the structures below. R¹ is the same as defined above. When a plurality of Rs and R¹s are present in the molecule, they may be identical to or different from each other, and are preferably identical to each other in terms of synthetic suitability.

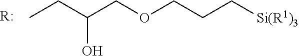

Component F may be obtained by synthesis as appropriate, but use of a commercially available product is preferable in terms of cost. Since Component F corresponds to for example commercially available silane products or silane coupling agents from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As the silane coupling agent in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Specific examples of such a partial (co)hydrolysis-condensation product include a partial (co)hydrolysis condensate obtained by using, as a precursor, one or more selected from the group of silane compounds consisting of alkoxysilanes or acetyloxysilanes such as tetramethoxysilane, tetraethoxysilane, methyltrimethoxysilane, methyltriethoxysilane, methyltriisopropoxysilane, methyltriacetoxysilane, methyltris(methoxyethoxy)silane, methyltris(methoxypropoxy)silane, ethyltrimethoxysilane, propyltrimethoxysilane, butyl trimethoxysilane, hexyltrimethoxysilane, octyltrimethoxysilane, decyltrimethoxysilane, cyclohexyltrimethoxysilane, phenyltrimethoxysilane, phenyltriethoxysilane, tolyltrimethoxysilane, chloromethyltrimethoxysilane, γ-chloropropyltrimethoxysilane, 3,3,3-trifluoropropyltrimethoxysilane, cyanoethyltriethoxysilane, γ-glycidoxypropyltrimethoxysilane, γ-glycidoxypropyltriethoxysilane, β-(3,4-epoxycyclohexyl)ethyltrimethoxysilane, γ-aminopropyltrimethoxysilane, γ-aminopropyltriethoxysilane, N-β-(aminoethyl)-γ-aminopropyltrimethoxysilane, N-phenyl-γ-aminopropyltrimethoxysilane, γ-mercaptopropyltrimethoxysilane, dimethyldimethoxysilane, dimethyldiethoxysilane, diethyldimethoxysilane, methylethyldimethoxysilane, methylpropyldimethoxysilane, diphenyldimethoxysilane, diphenyldiethoxysilane, methylphenyldimethoxysilane, γ-chloropropylmethyldimethoxysilane, 3,3,3-trifluoropropylmethyldimethoxysilane, γ-glycidoxypropylmethyldiethoxysilane, γ-aminopropylmethyldiethoxysilane, N-β-(aminoethyl)-γ-aminopropylmethyldimethoxysilane and γ-mercaptopropylmethyldiethoxysilane, and an acyloxysilane such as ethoxalyloxysilane.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable. Specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is preferable to use a dimer (2 moles of silane compound is reacted with 1 mole of water to eliminate 2 moles of alcohol, thus giving a disiloxane unit) of the silane compounds cited above to 100-mer of the above-mentioned silane compound, more preferably a dimer to 50-mer, and yet more preferably a dimer to 30-mer, and it is also possible to use a partial (co)hydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

In the resin composition for laser engraving of the present invention, the content of Component F is preferably 1 to 40 mass % of the total solids content, more preferably 3 to 30 mass %, and yet more preferably 5 to 20 mass %.

It is preferable for the content of Component F to be in this range since the engraving residue rinsing properties and printing durability are excellent.

### (Component G) Radically Polymerizable Compound

The resin composition for laser engraving of the present invention preferably comprises (Component G) a radically polymerizable compound. The radically polymerizable compound is preferably (Component G-1) a polyfunctional ethylenically unsaturated compound and may comprise a combination of the polyfunctional ethylenically unsaturated compound and (Component G-2) a monofunctional ethylenically unsaturated compound. With regard to Component G, one type may be used on its own or two or more types may be used in combination, and although there are no particular limitations it is preferable for at least Component G-1 to be contained.

The molecular weight (when there is a molecular weight distribution, the number-average molecular weight) of Component G is less than 4,500, preferably 100 to 4,000, and more preferably 150 to 2,000. It is preferable for the molecular weight to be in this range since the printing durability is good.

### (Component G-1) Polyfunctional Ethylenically Unsaturated Compound

The resin composition for laser engraving of the present invention preferably comprises as Component G (Component G-1) a polyfunctional ethylenically unsaturated compound.

The polyfunctional ethylenically unsaturated compound is preferably a compound having 2 to 20 terminal ethylenically unsaturated groups. A group of such compounds is widely known in the present industrial field, and in the present invention they may be used without any particular limitation. They may be in a chemical configuration such as for example a monomer, a prepolymer, that is, a dimer, a trimer, or an oligomer, a copolymer thereof, or a mixture thereof.

Examples of compounds from which the ethylenically unsaturated group in the polyfunctional monomer is derived include unsaturated carboxylic acids (such as acrylic acid, methacrylic acid, itaconic acid, crotonic acid, isocrotonic acid and maleic acid), and esters and amides thereof. Preferably esters of an unsaturated carboxylic acid and an aliphatic polyhydric alcoholic compound, or amides of an unsaturated carboxylic acid and an aliphatic polyvalent amine compound are used. Moreover, addition reaction products of unsaturated carboxylic acid esters or amides having a nucleophilic substituent such as a hydroxyl group or an amino group with polyfunctional isocyanates or epoxies, and dehydrating condensation reaction products with a polyfunctional carboxylic acid, etc. are also used favorably. Moreover, addition reaction products of unsaturated carboxylic acid esters or amides having an electrophilic substituent such as an isocyanato group or an epoxy group with monofunctional or polyfunctional alcohols or amines, and substitution reaction products of unsaturated carboxylic acid esters or amides having a leaving group such as a halogen group or a tosyloxy group with monofunctional or polyfunctional alcohols or amines are also favorable. Moreover, as another example, the use of compounds obtained by replacing the unsaturated carboxylic acid with a vinyl compound, an allyl compound, an unsaturated phosphonic acid, styrene or the like is also possible.

The ethylenically unsaturated group contained in the polyfunctional ethylenically unsaturated compound is preferably an acrylate, methacrylate, vinyl compound, or allyl compound residue from the viewpoint of reactivity, and more preferably an acrylate or methacrylate residue.

Specific examples of ester monomers comprising an ester of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

As isocrotonic acid esters there can be cited ethylene glycol diisocrotonate, pentaerythritol diisocrotonate, and sorbitol tetraisocrotonate.

As maleic acid esters there can be cited ethylene glycol dimaleate, triethylene glycol dimaleate, pentaerythritol dimaleate, and sorbitol tetramaleate.

As examples of other esters, aliphatic alcohol-based esters described in JP-B-46-27926, JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture.

Furthermore, specific examples of amide monomers including an amide of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based addition-polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (i) below is added to a polyisocyanate compound having two or more isocyanate groups per molecule described in JP-B-48-41708.

CH₂═C(R)COOCH₂CH(R′)OH (i)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure in the molecule described in JP-A-63-277653, JP-A-63-260909, and JP-A-1-105238, a resin composition having excellent curing speed can be obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Examples of the vinyl compounds include butanediol-1,4-divinyl ether, ethylene glycol divinyl ether, 1,2-propanediol divinyl ether, 1,3-propanediol divinyl ether, 1,3-butanediol divinyl ether, 1,4-butanediol divinyl ether, neopentyl glycol divinyl ether, trimethylolpropane tirvinyl ether, trimethylolethane tirvinyl ether, hexanediol divinyl ether, tetraethylene glycol divinyl ether, pentaerythritol divinyl ether, pentaerythritol tirvinyl ether, pentaerythritol tetravinyl ether, sorbitol tetravinyl ether, sorbitol pentavinyl ether, ethylene glycol diethylenevinyl ether, ethylene glycol dipropylenevinyl ether, trimethylolpropane triethylenevinyl ether, trimethylolpropane diethylenevinyl ether, pentaerythritol diethylenevinyl ether, pentaerythritol triethylenevinyl ether, pentaerythritol tetraethylenevinyl ether, 1,1,1-tris[4-(2-vinyloxyethoxy)phenyl]ethane, bisphenol A divinyloxyethyl ether, divinyl adipate, etc.

Examples of the allyl compounds include polyethylene glycol diallyl ether, 1,4-cyclohexane diallyl ether, 1,4-diethylcyclohexyl diallyl ether, 1,8-octane diallyl ether, trimethylolpropane diallyl ether, trimethylolethane triallyl ether, pentaerythritol triallyl ether, pentaerythritol tetraallyl ether, dipentaerythritol pentaallyl ether, dipentaerythritol hexaallyl ether, diallyl phthalate, diallyl terephthalate, diallyl isophthalate, triallyl isocyanurate, triallyl phosphate, etc.

In particular, from the viewpoint of excellent compatibility between Component A to Component C and engraving sensitivity being enhanced due to the crosslinked portion being a skeleton having the same low temperature decomposability as an acrylic resin, Component G-1 is preferably a (meth)acrylate compound.

Among them, preferred examples of Component G-1 include diethylene glycol di(meth)acrylate, dipentaerythritol hexa(meth)acrylate, tricyclodecanedimethanol di(meth)acrylate, trimethylolpropane tri(meth)acrylate, pentaerythritol tetra(meth)acrylate, and 1,6-hexanediol di(meth)acrylate.

The resin composition for laser engraving of the present invention may employ only one type of Component G-1 or two or more types in combination.

From the viewpoint of the brittleness and flexibility of a crosslinked film, the total content of the polyfunctional ethylenically unsaturated compound (Component G-1) in the resin composition for laser engraving of the present invention is preferably 0.1 to 40 mass % relative to the total solids content of the resin composition, and is more preferably in the range of 1 to 20 mass %.

### (Component G-2) Monofunctional Ethylenically Unsaturated Compound

The resin composition for laser engraving of the present invention may comprise (Component G-2) a monofunctional ethylenically unsaturated compound, but when the monofunctional ethylenically unsaturated compound (Component G-2) is contained it is preferable for the composition to comprise the polyfunctional ethylenically unsaturated compound (Component G-1) in combination.

Examples of the monofunctional ethylenically unsaturated compound, which has one ethylenically unsaturated bond in the molecule, include an ester of an unsaturated carboxylic acid (e.g. acrylic acid, methacrylic acid, itaconic acid, crotonic acid, isocrotonic acid, maleic acid, etc.) and a monohydric alcohol compound, and an amide of an unsaturated carboxylic acid and a monovalent amine compound.

The product of an addition reaction of an unsaturated carboxylic acid ester or amide having a nucleophilic substituent such as a hydroxy group, an amino group, or a mercapto group with an isocyanate or an epoxy, the product of a dehydration-condensation reaction with a monofunctional or polyfunctional carboxylic acid, etc. are also desirably used.

Moreover, as a radically polymerizable compound, addition reaction products of unsaturated carboxylic acid esters or amides having an electrophilic substituent such as an isocyanato group or an epoxy group with alcohols, amines or thiols, and substitution reaction products of unsaturated carboxylic acid esters or amides having a leaving group such as a halogen group or a tosyloxy group with alcohols, amines, or thiols are also favorable.

Moreover, as another example, the use of compounds obtained by replacing the unsaturated carboxylic acid with an unsaturated phosphonic acid, styrene, vinyl ether or the like is also possible.

As the polymerizable compound, the above examples of compound and various known compounds can be used without any particular limitation, and for example, compounds disclosed in JP-A-2009-204962 may be used.

The resin composition for laser engraving of the present invention may employ only one type of Component G-2 or two or more types in combination.

From the viewpoint of the brittleness and flexibility of a crosslinked film, the total content of the monofunctional ethylenically unsaturated compound (Component G-2) in the resin composition for laser engraving of the present invention is preferably 0.1 to 40 mass % relative to the total solids content of the resin composition, and is more preferably in the range of 1 to 20 mass %.

From the viewpoint of the brittleness and flexibility of a crosslinked film, the total content of Component G in the resin composition for laser engraving of the present invention is preferably 0.1 to 40 mass % relative to the total solids content of the resin composition, and more preferably 1 to 20 mass %.

### (Component H) a Plasticizer

The resin composition of the present invention contains preferably (Component H) a plasticizer from the viewpoint of giving flexibility necessary as a flexographic printing plate.

As the plasticizer, ones known as a plasticizer for polymer may be employed. Examples thereof include, although not limited, adipic acid derivatives, azelaic acid derivatives, benzoyl acid derivatives, citric acid derivatives, epoxy derivatives, glycol derivatives, hydrocarbons and derivatives thereof, oleic acid derivatives, phosphoric acid derivatives, phthalic acid derivatives, polyester-based materials, ricinoleic acid derivatives, sebacic acid derivatives, stearic acid derivatives, sulfonic acid derivatives, terpene and derivatives thereof, and trimellitic acid derivatives, as described in “Kobunshi Daijiten (Comprehensive Dictionary of Polymers)” (first edition, 1994, Maruzen) pages 211 to 220. Among these, from the viewpoint of a large effect of lowering the glass transition temperature, adipic acid derivatives, citric acid derivatives and phosphoric acid derivatives are preferable.

As the adipic acid derivatives, dibutyl adipate and 2-butoxyethyl adipate are preferable.

As the citric acid derivatives, tributyl citrate is preferable.

Examples of the phosphoric acid derivatives include tributyl phosphate, tri-2-ethylhexyl phosphate, tributoxyethyl phosphate, triphenyl phosphate, cresyldiphenyl phosphate, tricresyl phosphate, t-butylphenyl phosphate, 2-ethylhexyldiphenyl phosphate, etc.

The resin composition for laser engraving of the present invention may use Component H in one kind alone, or in two or more kinds in combination.

From the viewpoint of lowering the glass transition temperature to room temperature or less, the content of Component H in the resin composition for laser engraving of the present invention is, on a solid content basis while defining the total mass of the resin composition as 100 mass %, preferably 1 to 50 mass %, more preferably 10 to 40 mass %, and yet more preferably 20 to 30 mass %.

### (Component I) Filler

The resin composition for laser engraving of the present invention may comprise (Component I) a filler in order to improve the physical properties of a cured film of the resin composition for laser engraving.

As the filler, a known filler may be used, and examples thereof include inorganic particles and organic resin particles.

As the inorganic particles, known particles may be used, and examples thereof include carbon nanotubes, fullerene, graphite, silica, alumina, aluminum, and calcium carbonate.

As the organic resin particles, known particles may be used, and preferred examples thereof include thermally expandable microcapsules.

As the thermally expandable microcapsules, EXPANCEL (Akzo Noble) can be cited.

The resin composition for laser engraving of the present invention may employ only one type of Component I or two or more types in combination.

The content of the filler (Component I) in the resin composition for laser engraving of the present invention is preferably 0.01 to 20 mass % relative to the total solids content of the resin composition, more preferably 0.05 to 10 mass %, and particularly preferably 0.1 to 5 mass %.

### (Component J) Binder Polymer

The resin composition for laser engraving of the present invention may comprise (Component J) a binder polymer (hereinafter, also called simply a ‘binder polymer’) that is a resin component other than Component A, but the content thereof is preferably less than the content of Component A, more preferably no greater than 50 mass % of the content of Component A, yet more preferably no greater than 10 mass %, and particularly preferably none, that is, the binder polymer (Component J) being not contained.

The binder polymer is a polymer component contained in the resin composition for laser engraving; a usual polymer compound is appropriately selected, and one type may be used on its own or two or more types may be used in combination. In particular, when the resin composition for laser engraving is used in a printing plate precursor, it is preferably selected while taking into consideration various aspects of performance such as laser engraving properties, ink acceptance/transfer, and engraving residue dispersibility.

Examples of the binder polymer include binder polymers described in paragraphs 0009 to 0030 of JP-A-2012-045801.

The resin composition for laser engraving of the present invention may employ only one type of Component J or two or more types in combination.

### (Component K) Solvent

The resin composition for laser engraving of the present invention may comprise a solvent.

From the viewpoint of dissolving each of the components, a solvent is preferably mainly an aprotic organic solvent. More specifically, solvents are used preferably at aprotic organic solvent/protic organic solvent=100/0 to 50/50 (ratio by mass), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among them, propylene glycol monomethyl ether acetate is preferable.

### <Other Additives>

To the resin composition for laser engraving of the present invention, additives other than Component A to Component K may be added suitably in a range that does not hinder the effect of the present invention. Examples thereof include wax, a process oil, a metal oxide, an ozone decomposition inhibitor, an antioxidant, a thermal polymerization inhibitor, a colorant, a fragrance, a alcohol exchange reaction catalyst, etc. With regard to these additives, only one type may be used or two or more types may be used in combination.

The resin composition for laser engraving of the present invention preferably comprises a fragrance in order to reduce odor. A fragrance is effective in reducing odor during production of a relief printing plate precursor or during laser engraving. Examples of the fragrance include fragrances described in paragraphs 0081 to 0089 of JP-A-2011-245818.

The resin composition for laser engraving of the present invention may comprise, as an additive for improving engraving sensitivity, nitrocellulose or a high thermal conductivity material.

Since nitrocellulose is a self-reactive compound, it generates heat during laser engraving, thus assisting thermal decomposition of a coexisting binder polymer. It is surmised that as a result, the engraving sensitivity improves.

A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer or a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition.

For the purpose of coloring the resin composition for laser engraving, a colorant such as a dye or a pigment may be added. This enables properties such as visibility of an image area or suitability for an image densitometer to improve.

### (Relief Printing Plate Precursor for Laser Engraving)

A first embodiment of the relief printing plate precursor for laser engraving of the present invention comprises a relief-forming layer formed from the resin composition for laser engraving of the present invention.

A second embodiment of the relief printing plate precursor for laser engraving of the present invention comprises a crosslinked relief-forming layer formed by crosslinking a relief-forming layer formed from the resin composition for laser engraving of the present invention.

In the present invention, the ‘relief printing plate precursor for laser engraving’ means both or one of a precursor having a crosslinkable relief-forming layer formed from the resin composition for laser engraving in a state before being crosslinked and a precursor in a state in which the layer is cured by light or heat.

In the present invention, the ‘relief-forming layer’ means a layer in a state before being crosslinked, that is, a layer formed from the resin composition for laser engraving of the present invention, which may be dried as necessary.

In the present invention, the ‘crosslinked relief-forming layer’ means a layer formed by crosslinking the relief-forming layer. The crosslinking is carried out by means of heat and/or light. Furthermore, the crosslinking is not particularly limited as long as it is a reaction by which the resin composition is cured, and is a concept that includes a structure crosslinked due to a reaction between Components A, and between Component B and Component C.

Moreover, in the present invention, the ‘relief layer’ means a layer of the relief printing plate formed by engraving using a laser, that is, the crosslinked relief-forming layer after laser engraving.

The ‘relief printing plate’ can be obtained by laser engraving the printing plate having a crosslinked relief-forming layer.

The relief printing plate precursor for laser engraving of the present invention has a relief-forming layer formed from a resin composition for laser engraving comprising the above-mentioned components. The (crosslinked) relief-forming layer is preferably provided above a support.

The relief printing plate precursor for laser engraving may further comprise, as necessary, an adhesive layer between the support and the (crosslinked) relief-forming layer and, above the (crosslinked) relief-forming layer, a slip coat layer and a protection film.

### <Relief-Forming Layer>

The relief-forming layer is a layer formed from the resin composition for laser engraving of the present invention and is preferably a thermally crosslinkable layer.

As a mode in which a relief printing plate is prepared using the relief printing plate precursor for laser engraving, a mode in which a relief printing plate is prepared by crosslinking a relief-forming layer to thus form a relief printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a relief printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

A case in which the relief-forming layer is mainly formed in a sheet shape is explained as an Example below.

### <Support>

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), or polybutylene terephthalate (PBT)), polyacrylonitrile (PAN) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Relief Printing Plate Precursor for Laser Engraving)

The process for producing a relief printing plate precursor for lase engraving is not particularly limited, and examples thereof include a method in which the resin composition for laser engraving is prepared, solvent is removed from as necessary this coating solution composition for laser engraving, and it is melt-extruded onto a support. Alternatively, a method may be employed in which the coating solution composition for laser engraving is cast onto a support, and this is dried in an oven to thus remove solvent from the coating solution composition.

Among them, the process for producing a relief printing plate for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a relief printing plate precursor having a crosslinked relief-forming layer.

Subsequently, as necessary, a protection film may be laminated on the (crosslinked) relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing a relief printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove solvent.

The resin composition for laser engraving may be produced by, for example, dissolving or dispersing Component A to Component D, and as optional components Component E to Component J, etc. in an appropriate solvent, and then mixing the solution. Since it is preferably to remove most of the solvent component in a stage of producing a relief printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the (crosslinked) relief-forming layer in the relief printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

### <Crosslinking Step>

The process for producing a relief printing plate precursor for laser engraving of the present invention is preferably a production process that comprises a crosslinking step of thermally crosslinking the relief-forming layer to thus obtain a relief printing plate precursor having a crosslinked relief-forming layer.

The relief-forming layer may be crosslinked by heating the relief printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

Due to the relief-forming layer being thermally crosslinked, firstly, a relief formed after laser engraving becomes sharp and, secondly, tackiness of engraving residue formed during laser engraving is suppressed.

In the present invention, in the crosslinking step, polymerization reactions between Component A, and between Component B and Component C carry out.

In addition, since by using a photopolymerization initiator or the like, the polymerizable compound is polymerized to form a crosslink, the crosslinking may be further carried out by means of light.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need to be irradiated with light, but when the support is a transparent film through which actinic radiation passes, it is preferable to further irradiate from the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

### (Relief Printing Plate and Process for Making Same)

The process for making a relief printing plate of the present invention preferably comprises a layer formation step of forming a relief-forming layer from the resin composition for laser engraving of the present invention, a crosslinking step of crosslinking the relief-forming layer by means of heat to thus obtain a relief printing plate precursor having a crosslinked relief-forming layer, and an engraving step of laser-engraving the relief printing plate precursor having the crosslinked relief-forming layer.

The relief printing plate of the present invention is a relief printing plate having a relief layer obtained by crosslinking and laser-engraving a layer formed from the resin composition for laser engraving of the present invention, and is preferably a relief printing plate made by the process for making a relief printing plate of the present invention.

The relief printing plate of the present invention may suitably employ a UV ink and an aqueous ink when printing.

The layer formation step and the crosslinking step in the process for making a relief printing plate of the present invention mean the same as the layer formation step and the crosslinking step in the above-mentioned process for producing a relief printing plate precursor for laser engraving, and preferred ranges are also the same.

### <Engraving Step>

The process for making a relief printing plate of the present invention preferably comprises an engraving step of laser-engraving the relief printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, and one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ (The Laser Society of Japan), ‘Jitsuyo Laser Gijutsu’ (Applied Laser Technology) (The Institute of Electronics and Communication Engineers), etc.

Moreover, as plate making equipment comprising a fiber-coupled semiconductor laser that can be used suitably in the process for making a relief printing plate employing the relief printing plate precursor of the present invention, those described in detail in JP-A-2009-172658 and JP-A-2009-214334 can be cited.

The process for making a relief printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid containing water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid containing water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, yet more preferably no greater than 13.2, and particularly preferably no greater than 13. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 mass %.

The relief printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the relief printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The relief printing plate of the present invention can be used in printing by a letterpress printer using any one of an aqueous, oil-based, and UV inks, and printing is also possible by a flexographic printer using a UV ink. The relief printing plate of the present invention has excellent rinsing properties, there is little engraved residue, the relief layer obtained has excellent elasticity, and the relief printing plate has excellent printing durability, and printing can be carried out for a long period of time without plastic deformation of the relief layer or degradation of printing durability.

In accordance with the present invention, there can be provided a relief printing plate precursor for laser engraving and a process for producing same, in which engraving residue rinsing properties and engraving sensitivity are excellent and film surface tackiness is suppressed. There can also be provided a resin composition for laser engraving that is suitably used for such a printing plate precursor. Moreover, in accordance with the present invention, there can be provided a relief printing plate having excellent ink transfer properties and a process for making same.

### EXAMPLE

The present invention is explained in further detail below by reference to Examples, but the present invention should not be construed as being limited to these Examples. Furthermore, ‘parts’ in the description below means ‘parts by mass’, and ‘%’ means ‘mass %’, unless otherwise specified.

Moreover, the number-average molecular weight (Mn) of a polymer in the Examples are values measured by a Gel Permeation Chromatography (GPC) method (eluent: tetrahydrofuran) unless otherwise specified.

Details of the components used in each of the Examples and Comparative Examples are as follows.

### (Component A) Polyurethane Having Ethylenically Unsaturated Group and Having Number-Average Molecular Weight of at Least 5,000

### <Synthesis of Polyurethane (P-1)>

A separable flask equipped with a thermometer, a stirrer, and a reflux condenser was charged with 449.33 parts of a polycarbonate diol (PLLACCEL CD220PL) (Mn: 2,000, OH value: 55.0 mgKOH/g) manufactured by Daicel and 12.53 parts of tolylene diisocyanate, and a reaction was carried out while heating at 80° C. for about 3 hours. Subsequently, 47.77 parts of 2-methacryloyloxyethyl isocyanate was added thereto, and a reaction was carried out for about a further 3 hours, thus giving a polyurethane (P-1) having terminal methacrylic groups (average number of polymerizable unsaturated groups per molecule was about 2) and having a number-average molecular weight of about 30,000. This resin was a syrup at 20° C., flowed when an external force was applied, and did not recover to the original shape even when the external force was removed, that is, it was a plastomer.

### <Synthesis of Polyurethane (P-2)>

A separable flask equipped with a thermometer, a stirrer, and a reflux condenser was charged with 500 parts of a polyisoprenepolyol (trademark: LIR-506) (Mn: 16,400, OH value: 17.1 mgKOH/g) manufactured by Kuraray Co., Ltd. and 23.65 parts of 2-methacryloyloxyethyl isocyanate, and a reaction was carried out while heating at 60° C. for 7 hours, thus giving a resin (P-2) having terminal methacrylic groups (average number of polymerizable unsaturated groups per molecule was about 5) and a number-average molecular weight of 17,200. This resin was a syrup at 20° C., flowed when an external force was applied, and did not recover to the original shape even when the external force was removed, that is, it was a plastomer.

### <Synthesis of Polyurethane (P-3)>

A separable flask equipped with a thermometer, a stirrer, and a reflux condenser was charged with 500 parts of a polytetramethylene glycol (Mn: 1,830, OH value: 61.3 mgKOH/g) manufactured by Asahi Kasei and 52.40 parts of tolylene diisocyanate, and a reaction was carried out while heating at 60° C. for about 3 hours. Subsequently, 25.24 parts of 2-hydroxypropyl methacrylate and 31.75 parts of polypropylene glycol monomethacrylate (Mn: 400) were added thereto and reacted for a further 2 hours, thus giving a resin (P-3) having terminal methacrylic groups (average number of polymerizable unsaturated groups per molecule was about 2) and a number-average molecular weight of about 20,000. This resin was a syrup at 20° C., flowed when an external force was applied, and did not recover to the original shape even when the external force was removed, that is, it was a plastomer.

### <Synthesis of Polyurethane (P-4)>

Polyurethane P-4 having no ethylenically unsaturated group at a main chain terminal was synthesized in the same manner as for Polyurethane P-1 except that the 47.77 parts of 2-methacryloyloxyethyl isocyanate in the synthesis of Polyurethane P-1 was changed to 20 parts of methanol. The number-average molecular weight of Polyurethane P-4 was about 32,000; this resin was a syrup at 20° C., flowed when an external force was applied, and did not recover to the original shape even when the external force was removed, that is, it was a plastomer.

TR2000 (SBR resin, JSR)

### (Component B) Compound Having at Least Two Isocyanate Groups in Molecule

Isophorone diisocyanate (Tokyo Chemical Industry Co., Ltd.)
Duranate TPA-100: hexamethylene diisocyanate non-yellowing polyisocyanate (Asahi Kasei Chemicals Corporation, number-average molecular weight: 600, isocyanate group mass %: 23 mass %, average number fn of isocyanate groups: 3.3)
Duranate TLA-100: hexamethylene diisocyanate non-yellowing polyisocyanate (Asahi Kasei Chemicals Corporation, number-average molecular weight: 540, isocyanate group mass %: 23.4 mass %, average number fn of isocyanate groups: 3.0)

### (Component C) Compound Having at Least Two Active Hydrogens in Molecule

Diethylene glycol (Wako Pure Chemical Industries, Ltd.)

### Trimethylolpropane (Tokyo Chemical Industry Co., Ltd.)

### Ethylenediamine (Tokyo Chemical Industry Co., Ltd.)

Duranol T4672 (polycarbonate diol, Asahi Kasei Chemicals Corp.)
KF-6003 (both termini carbinol-modified silicone oil, Shin-Etsu Chemical Co., Ltd.)
X-22-161A (both termini amino-modified silicone oil, Shin-Etsu Chemical Co., Ltd.)

### (Component D) Thermopolymerization Initiator

Perbutyl Z (t-butylperoxybenzoate, NOF Corporation)
(Component E) Photothermal Conversion Agent that can Absorb Light Having Wavelength of 700 to 1,300 nm
Carbon black #45L (Mitsubishi Chemical Corporation, particle size: 24 nm, specific surface area: 125 m²/g, DBP oil adsorption: 45 cm³/100 g)
(Component F) Compound Having Hydrolyzable Silyl Group and/or Silanol Group
KBE-846 (silane coupling agent, (CH₃CH₂O)₃Si—(CH₂)₃—SSSS—(CH₂)₃—Si (OCH₂CH₃)₃, Shin-Etsu Chemical Co., Ltd.)

### B-1 (Compound Represented by Formula (B-1) Below)

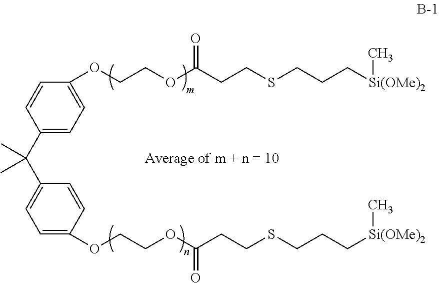

### (Component G) Radically Polymerizable Compound

A-BPE-4 (ethoxylated bisphenol A diacrylate (total of 4 mole ethylene oxide adduct), molecular weight 512, Shin-Nakamura Chemical Co., Ltd.)

### Examples 1 to 20 and Comparative Examples 1 to 5

### 1. Preparation of Resin Composition for Laser Engraving

A three-necked flask equipped with a stirring blade and a condenser was charged with 50 parts by mass of Component A described in Table 1, 20 parts by mass of Component B described in Table 1, and 25 parts by mass of Component C described in Table 1, and this mixed liquid was heated at 70° C. for 30 min. while stirring.

Subsequently, the mixed liquid was set at 40° C., and 1 part by mass of Component D described in Table 1, 3 parts by mass of Component E described in Table 1, and 10 parts by mass of Component F described in Table 1 were added thereto and stirred for 30 min.

Subsequently, as a fragrance 0.1 mass % (relative to the total solids content of the resin composition) of isobornyl acetate (Wako Pure Chemical Industries, Ltd.) was added thereto and stirred at 40° C. for 10 min.

This procedure gave flowable coating solutions for a crosslinkable relief-forming layer (resin compositions for laser engraving). When ‘none’ is entered in Table 1, said corresponding component was not added (the portion by mass of one that was not added was compensated for by increasing the total amount added of the other materials without changing the ratio of the amounts added).

Furthermore, in Example 19, a resin composition for laser engraving was prepared in the same manner as in Example 1 except that Component F was 5 parts by mass and Component G was 5 parts by mass.

### 2. Preparation of Relief Printing Plate Precursor for Laser Engraving

A spacer (frame) having a predetermined thickness was placed on a PET substrate, and the resin composition for laser engraving of each of Examples 1 to 18 and Comparative Examples 1 to 4 obtained above was cast gently so that it did not overflow from the spacer (frame) and heated in an oven at 90° C. to provide a relief-forming layer having a thickness of about 1 mm, thus preparing the relief printing plate precursor for laser engraving. In this process, heating was carried out in an oven at 90° C. until the surface tackiness completely disappeared, thus carrying out thermal crosslinking.

### 3. Making Relief Printing Plate

The relief-forming layer after crosslinking was engraved using the two types of laser below.

As a carbon dioxide laser engraving machine, for engraving by irradiation with a laser, an ML-9100 series high quality CO₂ laser marker (Keyence) was used. With regard to a printing plate precursor for laser engraving, a 1 cm square solid printed part was raster-engraved using the carbon dioxide laser engraving machine under conditions of an output of 12 W, a head speed of 200 mm/sec, and a pitch setting of 2,400 DPI.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed part was raster-engraved using the semiconductor laser engraving machine under conditions of a laser output of 7.5 W, a head speed of 409 mm/sec, and a pitch setting of 2,400 DPI.

The thickness of the relief layer of the relief printing plate of each of Examples 1 to 20 and Comparative Examples 1 to 5 was about 1 mm.

Furthermore, the Shore A hardness of the relief layer measured by the measurement method above was 75°.

### 4. Evaluation of Relief Printing Plate

The performances of a relief printing plate was evaluated in terms of the items below, and the results are shown in Table 1.

### (4-1) Engraving Sensitivity

The ‘engraving depth’ of a relief layer obtained by laser-engraving the relief-forming layer of the relief printing plate precursor was measured as follows. The ‘engraving depth’ referred to here means the difference between an engraved position (height) and an unengraved position (height) when a cross-section of the relief layer was examined. The ‘engraving depth’ in the present Examples was measured by examining a cross-section of a relief layer using a VK9510 ultradepth color 3D profile measurement microscope (Keyence Corporation). A large engraving depth means a high engraving sensitivity. The results are given in Table 1 for each of the types of laser used for engraving.

### (4-2) Rinsing Properties

A laser-engraved plate was immersed in water and an engraved part was rubbed with a toothbrush (Clinica Toothbrush Flat, Lion Corporation) 10 times. Subsequently, the presence/absence of residue on the surface of the relief layer was ascertained with an optical microscope. When there was no residue the evaluation was A, when there was almost no residue the evaluation was B, when there was a little residue the evaluation was C, when there was some residue but there was no practical problem the evaluation was D, and when the residue could not be removed the evaluation was E.

### (4-3) Ink Transfer Properties

A relief printing plate that had been obtained was set in a printer (Model ITM-4, IYO KIKAI SEISAKUSHO Co., Ltd.), as the ink Aqua SPZ16 Red aqueous ink (Toyo Ink Manufacturing Co., Ltd.) was used without dilution, and printing was carried out continuously using Full Color Form M 70 (Nippon Paper Industries Co., Ltd., thickness 100 μm) as the printing paper, and a highlight of 1% to 10% was confirmed for a printed material.

The degree of ink attachment in a solid printed part on the printed material at 1,000 m from the start of printing was compared by visual inspection.

With regard to the evaluation criteria, when there was no unevenness in density and there was uniform and slight gloss (gloss is an indicator that a considerable thickness (amount) of ink has been reliably transferred) the evaluation was A, when it was uniform without unevenness in density the evaluation was B, when there was unevenness over the whole area the evaluation was D, and when there was partial unevenness in density the evaluation was C. Evaluations of B and above are levels without problems in practice.

### (4-4) Amount of Paper Powder Attached (Film Surface Tackiness)

The amount of paper powder that became attached was used as an indicator for tackiness in accordance with the conditions below. The poorer the tackiness, the higher the amount of paper powder attached.

Sample size: 4 cm×4 cm
Paper powder: Paper Powder Fine (cellulose 100%), ZELATEX JAPAN

The amount of paper powder attached was measured as follows.

(I) A sample was weighed.
(II) Paper powder was spread on a tray, the sample was placed thereon with one side in contact with the paper powder and lightly pressed.
(III) The sample was slowly separated from the paper powder, excess paper powder was removed, and the sample was then weighed.
(IV) The amount of paper powder attached was calculated from the difference in mass between that before and that after the attachment of paper powder (g/m²).

TABLE 1

| | | | | | | | | | | | | Amount |
|---|---|---|---|---|---|---|---|---|---|---|---|---|
| | | | | | | | | Engraving | | | Ink | of paper |
| | | | | | | | | sensitivity | | Rinsing | transfer | powder |
| | Component | | | | | | | CO₂ | IR laser | proper- | proper- | attached |
| | A | B | C | D | E | F | G | laser | (FC-LD) | ties | ties | (g/m²) |
| Ex. 1 | P-1 | Isophorone | Diethylene | Perbutyl Z | None | None | None | 300 | 0 | C | B | 14 |
| | | diisocyanate | glycol | | | | | | | | | |
| Ex. 2 | P-1 | Isophorone | Trimethylol | Perbutyl Z | None | None | None | 330 | 0 | C | B | 12 |
| | | diisocyanate | propane | | | | | | | | | |
| Ex. 3 | P-1 | Duranate | Diethylene | Perbutyl Z | None | None | None | 330 | 0 | C | B | 11 |
| | | TPA-100 | glycol | | | | | | | | | |
| Ex. 4 | P-1 | Duranate | Ethylene- | Perbutyl Z | None | None | None | 320 | 0 | C | B | 12 |
| | | TPA-100 | diamine | | | | | | | | | |
| Ex. 5 | P-1 | Duranate | Duranol | Perbutyl Z | None | None | None | 330 | 0 | C | B | 12 |
| | | TPA-100 | T4672 | | | | | | | | | |
| Ex. 6 | P-1 | Duranate | KF-6003 | Perbutyl Z | None | None | None | 320 | 0 | C | B | 5 |
| | | TPA-100 | | | | | | | | | | |
| Ex. 7 | P-1 | Duranate | X-22-161A | Perbutyl Z | None | None | None | 330 | 0 | C | B | 5 |
| | | TPA-100 | | | | | | | | | | |
| Ex. 8 | P-2 | Duranate | Diethylene | Perbutyl Z | None | None | None | 330 | 0 | C | B | 12 |
| | | TPA-100 | glycol | | | | | | | | | |
| Ex. 9 | P-3 | Duranate | Diethylene | Perbutyl Z | None | None | None | 290 | 0 | C | B | 13 |
| | | TPA-100 | glycol | | | | | | | | | |
| Ex. 10 | P-1 | Isophorone | Diethylene | Perbutyl Z | Carbon | None | None | 330 | 390 | C | B | 12 |
| | | diisocyanate | glycol | | black #45L | | | | | | | |
| Ex. 11 | P-1 | Duranate | Diethylene | Perbutyl Z | Carbon | None | None | 350 | 420 | C | B | 10 |
| | | TLA-100 | glycol | | black #45L | | | | | | | |
| Ex. 12 | P-1 | Duranate | Ethylene- | Perbutyl Z | Carbon | None | None | 350 | 420 | C | B | 10 |
| | | TLA-100 | diamine | | black #45L | | | | | | | |
| Ex. 13 | P-1 | Duranate | Duranol | Perbutyl Z | Carbon | None | None | 360 | 432 | C | B | 10 |
| | | TLA-100 | T4672 | | black #45L | | | | | | | |
| Ex. 14 | P-1 | Duranate | KF-6003 | Perbutyl Z | Carbon | None | None | 350 | 420 | C | B | 5 |
| | | TLA-100 | | | black #45L | | | | | | | |
| Ex. 15 | P-1 | Duranate | X-22-161A | Perbutyl Z | Carbon | None | None | 350 | 420 | C | B | 4 |
| | | TLA-100 | | | black #45L | | | | | | | |
| Ex. 16 | P-1 | Duranate | KF-6003 | Perbutyl Z | Carbon | KBE-846 | None | 350 | 420 | B | B | 3 |
| | | TLA-100 | | | black #45L | | | | | | | |
| Ex. 17 | P-1 | Duranate | KF-6003 | Perbutyl Z | Carbon | KBE-846 | None | 350 | 420 | A | A | 3 |
| | | TLA-100 | diethylene | | black #45L | | | | | | | |
| | | | glycol | | | | | | | | | |
| Ex. 18 | P-1 | Duranate | KF-6003 | Perbutyl Z | Carbon | B-1 | None | 360 | 430 | A | A | 2 |
| | | TLA-100 | | | black #45L | | | | | | | |
| Ex. 19 | P-1 | Duranate | KF-6003 | Perbutyl Z | Carbon | B-1 | A-BPE-10 | 360 | 430 | A | A | 2 |
| | | TLA-100 | | | black #45L | | | | | | | |
| Ex. 20 | P-1 | Duranate | KF-6003 | Perbutyl Z | Carbon | B-1 | A-BPE-10 | 360 | 430 | A | A | 1 |
| | | TLA-100 | diethylene | | black #45L | | | | | | | |
| | | | glycol | | | | | | | | | |
| Comp. | TR2000 | Duranate | Diethylene | Perbutyl Z | None | None | None | 250 | 0 | E | D | 20 |
| Ex. 1 | | TPA-100 | glycol | | | | | | | | | |
| Comp. | TR2000 | Duranate | Diethylene | Perbutyl Z | Carbon | None | None | 250 | 280 | D | C | 18 |
| Ex. 2 | | TPA-100 | glycol | | black #45L | | | | | | | |
| Comp. | P-3 | Isophorone | Diethylene | None | Carbon | None | None | Crosslinked film not formed, | | | | |
| Ex. 3 | | diisocyanate | glycol | | black #45L | | | could not be evaluated | | | | |
| Comp. | P-3 | Duranate | None | Perbutyl Z | Carbon | None | None | Crosslinked film not formed, | | | | |
| Ex. 4 | | TPA-100 | | | black #45L | | | could not be evaluated | | | | |
| Comp. | P-4 | Isophorone | Diethylene | Perbutyl Z | Carbon | None | None | 270 | 320 | D | C | 17 |
| Ex. 5 | | diisocyanate | glycol | | black #45L | | | | | | | |

What is claimed is:

1. A resin composition for laser engraving, comprising:
(Component A) a polyurethane having an ethylenically unsaturated group and having a number-average molecular weight of at least 5,000;
(Component B) a compound having at least two isocyanate groups in the molecule;
(Component C) a compound having at least two active hydrogens in the molecule; and
(Component D) a thermopolymerization initiator.

2. The resin composition for laser engraving according to claim 1, wherein Component A is a plastomer at 20° C.

3. The resin composition for laser engraving according to claim 1, wherein Component A has an average number of ethylenically unsaturated groups per molecule of at least 0.7.

4. The resin composition for laser engraving according to claim 1, wherein Component A has an ethylenically unsaturated group at a main chain terminal.

5. The resin composition for laser engraving according to claim 1, wherein Component B is an isocyanate compound having an average number fn of isocyanate groups of greater than 2.

6. The resin composition for laser engraving according to claim 2, wherein Component B is an isocyanate compound having an average number fn of isocyanate groups of greater than 2.

7. The resin composition for laser engraving according to claim 1, wherein Component C comprises (Component C-1) a compound having a siloxane bond in the molecule and having at least two active hydrogens.

8. The resin composition for laser engraving according to claim 6, wherein Component C comprises (Component C-1) a compound having a siloxane bond in the molecule and having at least two active hydrogens.

9. The resin composition for laser engraving according to claim 1, wherein it further comprises (Component E) a photothermal conversion agent that can absorb light having a wavelength of 700 to 1,300 nm.

10. The resin composition for laser engraving according to claim 1, wherein it comprises at least two types of Component C, and at least one thereof is (Component C-1) a compound having a siloxane bond in the molecule and having at least two active hydrogens.

11. The resin composition for laser engraving according to claim 6, wherein it comprises at least two types of Component C, and at least one thereof is (Component C-1) a compound having a siloxane bond in the molecule and having at least two active hydrogens.

12. The resin composition for laser engraving according to claim 1, wherein it further comprises (Component F) a compound having a hydrolyzable silyl group and/or a silanol group.

13. The resin composition for laser engraving according to claim 8, wherein it further comprises (Component F) a compound having a hydrolyzable silyl group and/or a silanol group.

14. The resin composition for laser engraving according to claim 1, wherein it further comprises (Component G) a radically polymerizable compound.

15. The resin composition for laser engraving according to claim 13, wherein it further comprises (Component G) a radically polymerizable compound.

16. A relief printing plate precursor for laser engraving, comprising:
a crosslinked relief-forming layer formed by crosslinking a relief-forming layer comprising the resin composition for laser engraving according to claim 1 by means of heat.

17. A process for producing a relief printing plate precursor for laser engraving, comprising:
a layer formation step of forming a relief-forming layer from the resin composition for laser engraving according to claim 1; and
a crosslinking step of crosslinking the relief-forming layer by means of heat to thus obtain a relief printing plate precursor having a crosslinked relief-forming layer.

18. A relief printing plate precursor for laser engraving obtained by the process according to claim 17.

19. A process for making a relief printing plate, comprising in this order:
a step of preparing a relief printing plate precursor for laser engraving comprising a crosslinked relief-forming layer formed by crosslinking by means of heat a relief-forming layer comprising the resin composition for laser engraving according to claim 1; and
an engraving step of laser-engraving the crosslinked relief-forming layer so as to form a relief layer.

20. A relief printing plate comprising a relief layer made by the process for making a relief printing plate according to claim 19.
